(19) United States
(12) Patent Application Publication
(10) Pub. No.: US 2010/0094652 A1
(43) Pub. Date: Apr. 15, 2010

(54) System, method, and a computer program product for networking healthcare professionals

(76) Inventor: Thomas Christopher Dorsett, Austin, TX (US)

Correspondence Address: VENABLE LLP, P.O. BOX 34385, WASHINGTON, DC, 20043-9998, US

(21) Appl. No.: 12/285,701

(22) Filed: Oct. 10, 2008

(51) Int. Cl. G06F 17/30; G06F 21/00

(52) U.S. Cl. 705/3; 726/1; 707/E17.108

(57) ABSTRACT

A system, method, and computer program product for networking healthcare professionals in a manner which is fully complaint with the Health Insurance Portability and Accountability Act (HIPAA).

### COPYRIGHT NOTICE

Portions of the disclosure of this patent document may contain material that is subject to copyright protection. The copyright owner has no objection to the facsimile reproduction by anyone of the patent document or the patent disclosure, as it appears in the United States Patent and Trademark Office file or records, but otherwise reserves all copyright rights whatsoever.

### BACKGROUND OF THE INVENTION

1. Field of the Invention

The present invention in its disclosed embodiments is related generally to computer networks, and more particularly to a novel system, method, and computer program product for networking healthcare professionals.

2. Statement of the Prior Art

Various online communities, portals, and social networks for healthcare professionals are known. For example, iMedExchange is “a virtual doctor's lounge” available online at <<http://www.imedexchange.com>> [last accessed Oct. 7, 2008]. The website provides an online place for physicians to have discussions. Members post comments, which are then available for any other registered member of iMedExchange to read at any time. Comments, in turn, may then be organized into forums, topics, threads, and groups.

Forums are broken into three categories (e.g., business, clinical and personal) allowing members to share and discuss anything with their colleagues from their view on tort laws to their choice of wine. Topics are pre-defined sub-categories within the business, clinical, and personal forums. Members may select the topic most relevant to their discussion and either join an existing discussion (i.e., a thread), or the member's own. Threads are discussions within a topic. Groups can be public or private and provide a place for members with a specific shared interest to have discussions as well as share information, news, pictures and more about the interest.

Another online community, known simply as Sermo, is available online at <<http://www.sermo.com>> [last accessed Oct. 7, 2008]. It is a website owned and operated by Sermo, Inc., 215 First Street, Cambridge, Mass., which allows physicians to aggregate observations from their daily practice and then challenge or corroborate each other's opinions.

Online communities such as iMedExchange and Sermo, while intended to be professional social networks for sharing work experiences, discussing products and drugs, and having general conversations much like Friendster and Facebook do for the wider public, suffer from several disadvantages. The leading disadvantage of such online communities is that they constitute little more than “chat rooms”. They fail to address issues related to the Health Insurance Portability and Accountability Act (HIPAA), which was enacted by the United States Congress in 1996.

### SUMMARY OF THE INVENTION

Accordingly, it is generally an object of certain embodiments of the present invention to provide a system for physicians, nurses, and other healthcare professionals to, among other things, share patient-specific data, documents, and communications in a HIPAA-compliant environment.

More specifically, it is an object of those and other embodiments of the present invention to provide an easy way to universally share clinical data, and thereby replace the persistent dependence on prior art approaches of faxing documents back and forth, independent of any already installed electronic health records (“EHR”) system.

It is a further object of embodiments of the present invention to provide a way to refer patients to physicians, discover other physicians specializing in particular fields, and pass patient data along with the referral, all of which will be performed in a HIPAA-compliant environment.

Further objects, advantages, and novel features of the embodiments of the present invention and the structure and operation thereof, are described in detail below with reference to the accompanying drawings, wherein:

### BRIEF DESCRIPTION OF THE DRAWINGS

FIG. 1 depicts a block diagram of a system for networking healthcare professionals according to one embodiment of the present invention;

FIG. 2 depicts a block diagram illustrating a module-based architecture useful in systems, methods, and computer program products for networking healthcare professionals according to embodiments of the present invention;

FIG. 3 depicts a block diagram of a system for networking healthcare professionals according to another embodiment of the present invention;

FIG. 4 depicts a block diagram of a system for networking healthcare professionals according to yet another embodiment of the present invention;

FIG. 5 depicts a block diagram of a system for networking healthcare professionals according to still another embodiment of the present invention;

FIG. 6 depicts a block diagram illustrating software compatible for use in systems, methods, and computer program products for networking healthcare professionals according to embodiments of the present invention;

FIG. 7 depicts a block diagram of a Registration Module according to one embodiment of the present invention;

FIG. 8 depicts a web page which may be useful in implementing the Registration Module in systems, methods, and computer program products for networking healthcare professionals according to embodiments of the present invention;

FIG. 9 depicts a block diagram of a Profile Module according to one embodiment of the present invention;

FIGS. 10-12 depicts web pages which may be useful in implementing the Profile Module in systems, methods, and computer program products for networking healthcare professionals according to embodiments of the present invention;

FIG. 13 depicts a web page which helps implement Profile Module 900 by facilitating Master Settings;

FIG. 14 depicts a web page which helps implement Profile Module 900 by facilitating Downloads;

FIG. 15 depicts a block diagram of a Users Module according to one embodiment of the present invention;

FIG. 16 depicts a block diagram of a Contacts Module according to one embodiment of the present invention;

FIG. 17 depicts a web page which helps implement the My Contacts feature according to the Contacts Module shown in FIG. 16;

FIG. 18 depicts a web page which helps implement the Incoming Invites feature according to the Contacts Module shown in FIG. 16;

FIG. 19 depicts a web page which helps implement the Outgoing Invites feature according to the Contacts Module shown in FIG. 16;

FIG. 20 depicts a web page which helps implement the Bookmarks feature according to the Contacts Module shown in FIG. 16;

FIG. 21 depicts a web page which may be used to implement the Invite feature according to one embodiment of the present invention;

FIG. 22 depicts a web page which may be used to further implement the Invite feature for confirmed users according to one embodiment of the present invention;

FIG. 23 depicts a web page which may be used to further implement the Invite feature for unconfirmed users according to one embodiment of the present invention;

FIG. 24 depicts a web page which may be used to further implement the Invite feature for unaccepted users according to one embodiment of the present invention;

FIG. 25 depicts a block diagram of an Audit Trail Module according to one embodiment of the present invention;

FIG. 26 depicts a web page which may be used to implement the Audit Trail Module shown in FIG. 25;

FIG. 27 depicts a block diagram of a Messages Module according to one embodiment of the present invention;

FIGS. 28-30 depicts a web page which may be used to further implement the Messages Module shown in FIG. 27;

FIGS. 31-32 depict web pages which may be used to further implement the Messages Module shown in FIG. 27, particularly for referrals;

FIG. 33 depicts a block diagram of a Forum Module according to one embodiment of the present invention;

FIG. 34 depicts a block diagram of a Groups Module according to one embodiment of the present invention;

FIGS. 35-39 depict web pages which may be used to implement the Groups Module shown in FIG. 34;

FIG. 40 depicts a web page which may be used to implement the blogs section of the Groups Module shown in FIG. 34;

FIG. 41 depicts a block diagram of a CME Module according to one embodiment of the present invention;

FIG. 42 depicts a block diagram of a CME External Module according to one embodiment of the present invention;

FIG. 43 depicts a block diagram of a CME Internal Module according to one embodiment of the present invention;

FIG. 44 depicts a web page which may be used to implement the CME External Module shown in FIG. 42;

FIG. 45 depicts a web page which may be used to implement the CME Internal Module shown in FIG. 43;

FIGS. 46-48 depict web pages which may be used to implement safe and secure transmission and receipt of continuity of care records (“CCR”) in compliance with HIPAA;

FIG. 49 depicts a block diagram of a Search Module according to one embodiment of the present invention; and

FIGS. 50-51 depict web pages which may be used to implement event planning according to embodiments of the present invention.

### DETAILED DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. Persons of ordinary skill in the relevant art will recognize that other components and configurations may be used without departing from the true spirit and scope of the embodiments. It is to be understood that each specific element includes all technical equivalents that operate in a similar manner to accomplish a similar purpose. Therefore, the examples and embodiments described herein are non-limiting examples.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; and the like.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

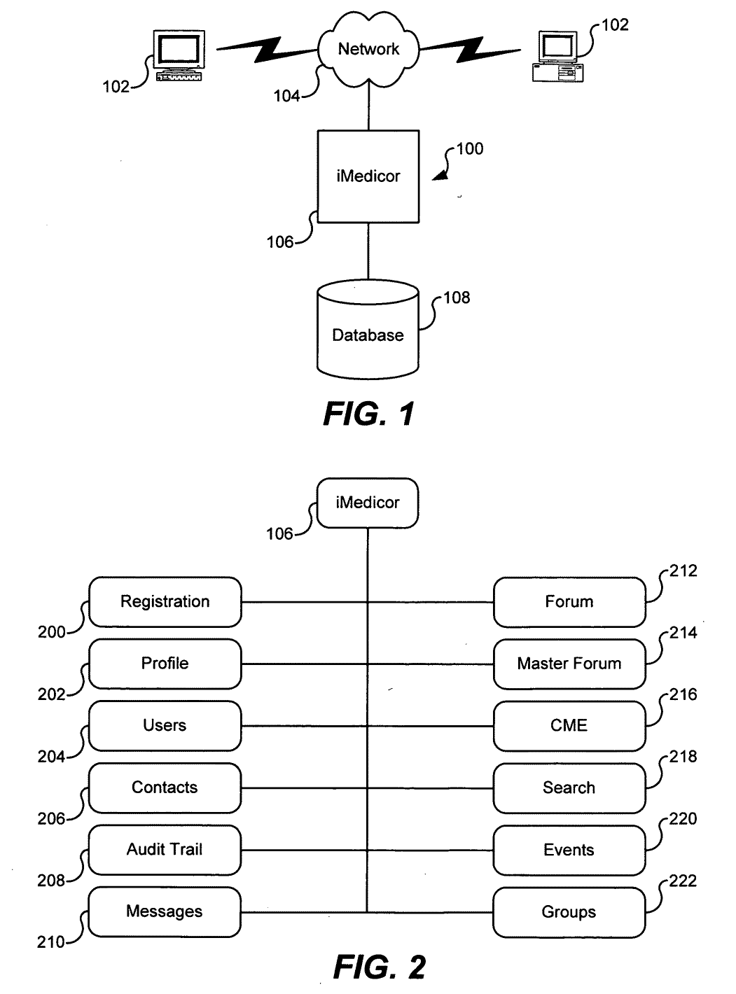

Referring now to the drawings, wherein like reference numerals and characters represent like or corresponding parts and steps throughout each of the many views, there is shown in FIG. 1 a schematic diagram of a system 100 for networking healthcare professionals in accordance with embodiments of the present invention.

System 100 is adapted to be accessed by physicians, nurses, and other healthcare professionals to, among other things, share patient-specific data, documents, and communications in a HIPAA-compliant environment, using a plurality of clients 102. Such clients 102, in turn, may suitably comprise one or more conventional computers or workstations, operating either as a “fat” client or a “thin” client. It should be understood, nevertheless, that other clients 102, such as Web-enabled hand-held devices (e.g., Palm handhelds manufactured by Palm, Inc., Santa Clara, Calif. U.S.A., Windows CE devices, and “smart” phones), which use the wireless access protocol, and Internet appliances fall within the true spirit and scope of various embodiments of the present invention.

Clients 102 of the above types may suitably access system 100 by way of a network 104. By use of the term “network”, it should be understood that the foregoing is not intended to limit the present invention to any particular wireline or wireless network, such as local area networks (LANs), metropolitan area networks (MANs), or wide area networks (WANs). Network 104 may comprise the Internet (also known as the “World Wide Web”), but it may similarly comprise intranets, extranets, and virtual private networks (VPNs) and the like. In accordance with presently preferred embodiments of the invention, system 100 may suitably be comprised of an application 106, and a database 108.

As shown in FIG. 2, application 106 may be developed as a plurality of modules 200, 202, 204, 206, 208, 210, 212, 214, 216, 218, 220, and 222 with Open Source software using a module-based architecture. Module 200 may comprise a plurality of instructions for the purposes of registering a user; module 202 may comprise a plurality of instructions to identify a user's profile; module 204 may comprise a plurality of instructions to identify a user; module 206 may comprise a plurality of instructions to identify a plurality of contacts; module 208 may comprise a plurality of instructions to establish an audit trail; module 210 may comprise a plurality of instructions for storing messages; module 212 may comprise a plurality of instructions to establish a forum; module 214 may comprise a plurality of instructions to establish a master forum; module 216 may comprise a plurality of instructions for the purposes of CME; module 218 may comprise a plurality of instructions for searching; module 220 may comprise a plurality of instructions to establish and schedule events; and module 222 may comprise a plurality of instructions to establish groups.

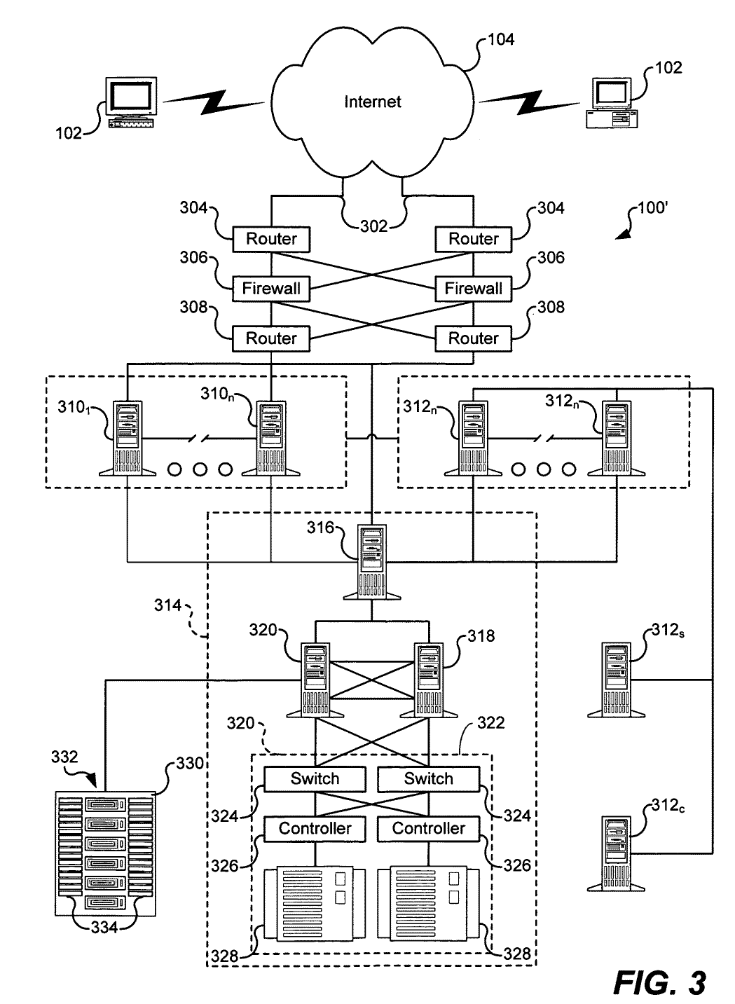

As shown in FIG. 3, system 100 may further comprise a pair of Internet access lines 302 (e.g., primary and shadow conventional T3 lines), which are cross-connected from the backbone of Internet 104 to one or more, and preferably, a pair of redundant routers 304, 308. Incoming traffic from the first of such routers 304 may then be suitably directed through a firewall 306 to the second of such routers 308. Even more preferably, and for the sake of redundancy, two firewalls 306 may be cross-connected as shown in FIG. 3. One exemplary router 304 that may be used is the SmartSwitch Router 8000, which is manufactured by the Enterasys Networks division of Cabletron Systems, Andover, Mass. USA. Moreover, an exemplary firewall 306 that may be used is an IP network application platform (e.g., the IP650, IP440, or IP330 firewall platforms, which are manufactured by Nokia Group, Espoo, Finland).

A plurality of web servers 310₁, 310₂, . . . 310n may, thus, be conveniently load balanced by use of the foregoing configuration. That is, the load of incoming traffic from the Internet 104, through the routers 304, 308 and firewalls 306, may be balanced among each of the web servers 310₁, 310₂, . . . 310ₙ. Certain incoming traffic may be routed to a particular web server 310₁, 310₂, . . . 310ₙ, where that particular web server 310₁, 310₂, . . . 310ₙ had been recently used by a given user whose information had been cached thereon. As a result, it may be more efficient to continue to use that particular web server 310₁, 310₂, . . . 310ₙ, such that no single one of the web servers 310₁, 310₂, . . . 310ₙ would become overburdened.

In an exemplary embodiment of the present invention, there are three such web servers. Each of the web servers 310₁, 310₂, . . . 310ₙ may be, in turn, preferably comprised of a Dell™ PowerEdge™ 2450 server (manufactured by Dell Computer Corporation, Austin, Tex. U.S.A.), with at least a 733 MHz Pentium III processor, 256 MB RAM, and dual, mirrored 9.1 GB fixed disk drives. Moreover, each of the web servers 310₁, 310₂, . . . 310ₙ may be further comprised of a Microsoft Windows® NT, Windows Server 2003, or better operating system, and Netscape Enterprise Server, Release 3.6.3 (developed by Netscape Communications, a subsidiary of America Online, Inc., Dulles, Va. U.S.A.). Optionally, Netscape's Certificate Server may also be installed on each of the web servers 310₁, 310₂, . . . 310ₙ to facilitate core digital certificate-issuance and management services, as well as distribution of certificates and certificate-revocation lists to clients and other servers. Other forms of certificate servers (e.g., web certificate servers and wireless certificate servers, which are available from VeriSign, Inc., Mountain View, Calif. U.S.A.) may likewise be deployed on each of the web servers 310₁, 310₂, . . . 310ₙ.

System 100 may further comprise a plurality of application servers 312₁, 312₂, . . . 312ₙ, coupled to the web servers 310₁, 310₂, . . . 310ₙ. In an exemplary embodiment of the present invention, there may be six such application servers. Each of the application servers 312₁, 312₂, . . . 312ₙ may, like the web servers 310₁, 310₂, . . . 310ₙ, be comprised of a Dell PowerEdge 3450 server, with at least a 733 MHz Pentium III processor, 256 MB RAM, and dual, mirrored 9.1 GB fixed disk drives. Moreover, each of the application servers 312₁, 312₂, . . . 312ₙ may be further comprised of a Microsoft Windows NT, Windows Server 2003, or better operating system, and the Total-e-Business™ platform (developed by Bluestone Software, Inc., Philadelphia, Pa. U.S.A., and including the Total-e-Business Server [formerly known as “Sapphire/Web”]). Bluestone's Universal Business™0 Server, Release 7.0, for example, may be used to manage application 106 and methods according to various embodiments of the present invention, while running on each of the application servers 312₁, 312₂, . . . 312ₙ. At the same time, Bluestone's Load Balance Broker (LBB) may be loaded on each of the web servers 310₁, 310₂, . . . 310ₙ, to facilitate balancing of the load of communications between each of the web servers 310₁, 310₂, . . . 310ₙ and each of the application servers 312₁, 312₂, . . . 312ₙ.

For example, when a request within the iMedicor application 106 is intended for one of the application servers 312₁, 312₂, . . . 312ₙ, it can go to one of potentially many instances of the application, which may reside on different machines. The task of ensuring that simultaneous requests may be distributed evenly across multiple instances, in order to ensure efficient processing, falls to the LBB.

Before one of ordinary skill in the art may understand how the LBB performs its load balancing, one may first appreciate its internal storage mechanism (i.e., how information about applications and their instances is stored therein). In essence, the following four fields are used to store information about all the instances in a specific application: (1) Host: the hostname of the instance, as contained in $SAPPHIRE/config/apserver.txt; (2) Port: the port allocated to this instance, also as contained in $SAPPHIRE/config/apserver.txt; (3) Usage: the number of requests currently being processed by this instance; and (4) Failed: whether or not communication to the host in general or the instance in specific has met with failure. At this juncture, somewhat more detailed descriptions of the Usage and Failed fields may be merited here.

Usage is the number of requests that are currently being handled by this instance. It is a factor used to ensure that the load is balanced evenly. Initially, a count of zero is assigned to the Usage field for all instances, because the maximum number of possible requests an instance may process at any given time is limited only by system resources. The usage count is incremented every time a request is passed off to the corresponding instance and is decreased once the request has been processed.

Failed is a flag which, if true (or on), means that communication to the application server instance failed on the last attempt. Initially, the status of this field is set to false (i.e., off) for all instances, because it is turned on only if the following sequence of events unfolds: (1) the LBB attempts to contact the instance and fails; (2) the LBB contacts a Dynamic Application Launcher (DAL) on the instance's machine to have the instance started; and (3) the LBB attempts to contact the instance and fails again. Once an instance has been marked as failed, it gets moved to the bottom of the list of instances to ensure that time is not wasted attempting to contact it any time soon. Also, the hostname of the instance gets added to a separately maintained list of failed hosts. Failed instances are ignored during the LBB's instance selection phase.

There are two ways a failed instance can be returned to “active duty” (i.e., its failed status is reset), allowing the instance to be reconsidered for future requests. Each failed instance has a timer that is started when the instance is marked as failed. After a certain amount of time has elapsed, the instance's failed flag is reset. This allows for situations where the communication problem might be temporary in nature. Once an instance is contacted, its hostname is removed from the list of failed hosts and any other failed instances going to the same hostname are also reset. At this point, the assumption is that communication problems tend to be network or server-related (i.e., the entire host machine tends to be down, not just a specific port thereon).

There are two exemplary versions of a load balancing algorithm that may be used by the LBB, one for use without session affinity and one with. In the former case (i.e., without session affinity), when a request is received, the entire list of instances is sequentially searched, starting from the first instance in the list and ignoring any failed instances. The entire list of valid instances, then, is searched for the instance with the lowest usage count. If multiple instances have the same low value, the first one found is used. The only time the search ends prematurely is if an instance with a usage count of zero (0) is found. This is because it is not possible to improve upon this usage count and, thus, this instance is used automatically. At this point in time, the usage count of the instance that is used is incremented.

In the latter case (i.e., with session affinity), the usage count of an instance goes up by one every time it is used to process a request. However, when the request is done, the usage count goes back down by one. In high load situations where multiple requests are submitted with little time in between, multiple instances of the application automatically handle these requests. However, in situations where the requests are somewhat further apart, the usage count of an instance might have time to go back down by the time the next request comes in, allowing a very small number of application server instances to process all the requests. This works well in cases where there is no session affinity. However, because of the characteristic of session affinity always ensuring the same instance of the application to a particular browser session, it would not be prudent to have a small number of application server instances handling multiple requests simply because they are not in quick succession. Toward this end, the LBB has an index pointer into the list of instances in case of session affinity.

When a request comes in and a session cookie is attached (e.g., it is not a first time user), it gets the very same instance which processed the request the last time. There is no load balancing to be performed here. If, however, the request is from a new session, the load balancing algorithm is much the same as without session affinity with a slight modification. The search for the least used application server instance starts with the instance pointed to by the index pointer instead of at the top of the list. Once an instance is used, the index pointer is incremented to point to the next instance in the list, with wrap-around capability, to ensure that the same instance is not bombarded with multiple requests. If a request with a session cookie points to an instance which has failed (or fails at this time) after three retries, the request is treated as if it were a new request and a new session cookie is assigned after load balancing is performed.

There is one primary difference between using session affinity and not doing so as far as load balancing is concerned. Without session affinity, load balancing occurs at each request. The load balancing process with session affinity, however, only occurs at the very first request, since subsequent requests get routed automatically to the same instance every time. Therefore, one of ordinary skill in the art may appreciate the circumstances under which the system 100 according to various embodiments of the present invention may require load balancing with or without session affinity.

Referring again to FIG. 3, it can be seen that beneath the layer of web servers 310₁, 310₂, . . . 310n and application servers 312₁, 312₂, . . . 312ₙ is a storage area network (SAN) 314. SAN 314 may generally comprise a cluster server 316 that is connected to receive incoming Internet traffic through each of the application servers 312₁, 312₂, . . . 312ₙ, and to transmit outgoing Internet traffic through the routers 304, 308 and firewall 306, from the SAN 314 by way of either a file server 318 or a database server 320. File server 318 and database server 320 each may be comprised of a Sun Enterprise™ 420R server (manufactured by Sun Microsystems, Inc., Palo Alto, Calif. U.S.A.) or better. In the case of the former, file server 318 may further comprise at least a pair of 450 MHz UltraSPARC-II processors with 2 GB ECC memory. Database server 320, on the other hand, may further comprise four UltraSPARC-II processors with at least 4 GB ECC memory. Accordingly, both file server 318 and database server 320 preferably run in a Solaris™ operating environment. Database server 320 may also preferably comprise Oracle 8i™, Release 2 or higher. System 100 may further comprise a state server 312_{S} and a content management server 312_{C}.

In accordance with an exemplary embodiment of the present invention, SAN 314 may also comprise a fiber channel switched network or fabric. It is known, for example, that such networks provide a high-performance, any-to-any interconnect for server-to-server or server-to-storage traffic. Fiber channel switched networks also combine the characteristics of traditional networks (e.g., large address space, scalability) and I/O channels (e.g., high speed, low latency, hardware error detection) on a single infrastructure. Additionally, fiber channel switched networks facilitate multiple protocols for networking (e.g., IP), storage (e.g., SCSI) and messaging (e.g., VIA) over a single infrastructure. This infrastructure can, therefore, be easily used to create SAN 314, in which peripheral devices such as disk storage 328 and tape libraries 332 can be attached to the network and shared among attached nodes. Some of the more desirable features of this approach to organizing the servers and storage of the present invention will now be described herein below.

Fiber channel fabrics such as SAN 314 may provide a switched 10 Mbytes/second or greater full duplex interconnect. In addition, block-level I/O may be handled with substantially better efficiency when compared to networking traffic. A single SCSI command can transfer many megabytes of data with very little protocol overhead, including CPU interrupts. As a result, relatively inexpensive hosts and storage devices can achieve very good utilization and throughput on the network. SAN 314 may also use a 24-bit addressing scheme, thereby permitting 16 million devices to be addressed. In an exemplary embodiment of the present invention, SAN 314 may further comprise a pair of cross-connected SilkWorm™ fiber channel switches 324 (manufactured by Brocade Communications Systems, Inc., San Jose, Calif. U.S.A.).

Traditional storage interconnects are limited in the length of cable that can attach hosts and storage units. Fiber channel allows links up to 10 kilometers, which vastly increases the options for the server administrator. SAN 314 allows a number of servers to utilize sections of SAN-attached storage devices. This allows for cost efficiencies that come from purchasing storage in large units. In addition, this arrangement makes it possible to ensure consistent quality and support across the entire server population. Externalizing the storage from the server also makes it a first class asset in its own right. Servers can, thus, be upgraded while leaving storage in place. Storage can be added at will and dynamically allocated to servers without downtime. Because the SAN 314 is extensible, it allows incremental deployment of features such as fault tolerance and hot backup sites.

In an exemplary embodiment, cluster server 316 comprises Veritas Cluster Server™ (developed by Veritas Software Corporation, Mountain View, Calif. U.S.A.). File server 318 and database server 320 may also be redundantly configured. That is, in the event that either of the servers goes down during a session, the other can assume control of that session with the assistance of the cluster server 316. VERITAS Database Edition™ for Oracle®/HA may, alternatively, be used. As a result, the database service may be composed of one or more logical network addresses (e.g., IP), RDBMS software, an underlying file system, a logical volume manager and a set of physical disks being managed by the volume manager. If this service, typically called a service group, needs to be migrated to another node for recovery purposes, all of its resources may be migrated together to re-create the service on another node. A single large node may host any number of service groups, each providing a discrete service to networked clients who may or may not know that they physically reside on a single node.

Service groups may, thus, be managed to maintain service availability through an intelligent availability management tool. Given the ability to test a service group to ensure that it is providing the expected service to networked clients and an ability to automatically start and stop it, such a service group may be made highly available. If multiple service groups are running on a single node, then they may be monitored and managed independently. Independent management allows a service group to be automatically recovered or manually idled (e.g., for administrative or maintenance reasons) without necessarily impacting any of the other service groups running on a node.

At the most basic level, the fault management process includes monitoring a service group and, when a failure is detected, restarting that service group automatically. This could mean restarting it locally or moving it to another node and then restarting it, as determined by the type of failure incurred. In the case of local restart in response to a fault, the entire service group does not necessarily need to be restarted; perhaps just a single resource within that group may need to be restarted to restore the application service. An agent typically monitors application services, which is a small, application-specific fault management program. Given that service groups may be independently manipulated, a failed node's workload can be load balanced across remaining cluster nodes, and potentially failed over successive times (i.e., due to consecutive failures over time) without manual intervention.

Application servers 312₁ through 312ₙ, in concert with the web servers 310₁, 310₂, . . . 310ₙ, file server 318, database server 320, and the clients 102, provide a conventional three-tiered architecture. As with similar such three-tiered architectures, application servers 312₁ through 312ₙ handle most of the application processing, such as business logic processing and database integrity processing. The clients 102 only handle interface processing, while the file server 318 and database server 320 only handle database processing. As seen in FIG. 3, the hardware comprising system 100 may be substantially completed with the addition of high-availability storage 322 cross-connected to the file server 318 and database server 320. One suitable such high-availability storage 322 comprises the fiber channel switches 324, a pair of disk controllers 326, and a pair of disk arrays 328. Each of the disk controllers 326 may be a SCSI controller (e.g., a Symbios® SYM53C1010 Ultra160 SCSI controller, manufactured by LSI Logic Corporation, Milpitas, Calif. U.S.A.). In an exemplary embodiment, the disk arrays 328 each may comprise twenty 36 GB LVD (i.e., low voltage differential) disk drives which are configured to be mirrored RAID 5. Suitable such LVD drives are, for example, the Ultrastar 36ZX hard disk drives manufactured by IBM Corporation, Armonk, N.Y. U.S.A.

System 100 may further comprise a tape library 330, which includes a plurality of advanced intelligent tape drives 332 (e.g., AIT2 tape drives or better) and a plurality storage positions 334 for the AIT2 tapes. In an exemplary embodiment, the tape library 330 comprises a TLS4000 automated tape library (manufactured by Qualstar Corporation, Canoga Park, Calif. U.S.A.), which can incorporate up to 12 AIT2 tape drives and has storage for at least 60 AIT2 tapes. Such tape library 330, may further comprise suitable software (e.g., Veritas Netbackup™) to control reading and writing of data to the tape library 330.

In accordance with an exemplary embodiment of the invention, system 100 may allow for the importation of data surrounding user accounts from the standard network security structure in place. Users of the system may be required to login in order to access the system. Preferably, such login may consist of a User Name and Password. After three unsuccessful login attempts, the system may lock out the user account attempting to login. An administrative level user may then be required to restore a locked out account. Moreover, an active session may timeout if no activity with the system is detected for 30 minutes. The system may log user activity and be capable of reporting user statistics.

Preferably, system 100 should support the use of the XML markup language. It should also support an extensive array of file types including graphic (e.g., DICOM, JPEG, GIF, BMP, etc.), audio (e.g., WAV, MP3, etc.), video (e.g., QIC, Real, AVI, MPEG, etc.), and Mixed Media (e.g., SWF, etc.).

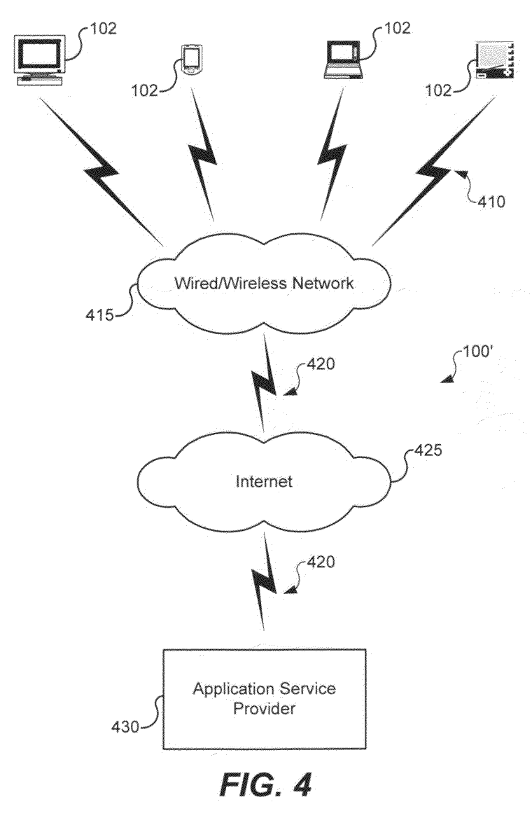

Referring now to FIG. 4, an alternative system 100′ for networking healthcare professionals according to another embodiment of the present invention is shown. Each of the plurality of clients 102 is wired and/or wirelessly coupled by a first coupling means 110 to a wired/wireless network 415. The wired/wireless network 415, in turn, is coupled by a second coupling means 420 to a large-scale network such as the Internet 425. It should be understood that the foregoing use of the term “Internet” is not intended to limit the present invention to a network also known as the World Wide Web. The present embodiment may likewise include intranets, extranets, Virtual Private Networks (VPNs), and the like.

Such second coupling means 420 may also be used to couple communications from the plurality of clients 102, through the wired/wireless network 415 and Internet 425, to an application service provider means 430. In turn, application service provider means 430 may comprise a network of computers coupled together (e.g., by way of an Ethernet), a three-tiered architecture as shown in FIG. 3, or any other suitable means for providing software as a service (“SaaS”). The clients 102, as well, may comprise a desktop computer or workstation, a tower computer or server, a laptop computer, a personal digital assistant (PDA), or a pen-based notebook.

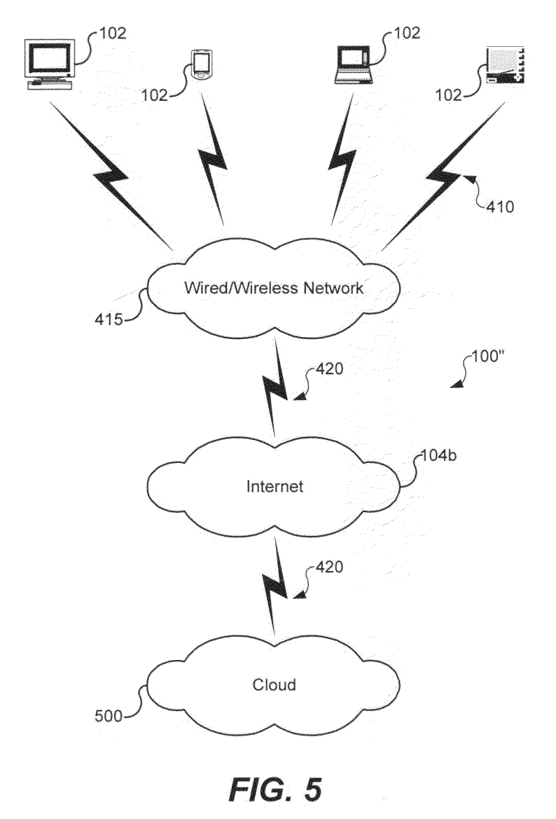

Referring now to FIG. 5, an alternative system 100″ for networking healthcare professionals according to yet another embodiment of the present invention is shown.. Like the system 100′ shown in FIG. 4, each of the plurality of clients 102 is wired and/or wirelessly coupled by a first coupling means 110 to a wired/wireless network 415. The wired/wireless network 415, in turn, is coupled by a second coupling means 420 to a large-scale network such as the Internet 425. Such second coupling means 420 may also be used to couple communications from the plurality of clients 102, through the wired/wireless network 415 and Internet 425. In the embodiment according to FIG. 5, however, system 100″ is adapted to be controlled by cloud computing means 500.

As would be known by those of ordinary skill in the art, the term “cloud computing” refers to a computing paradigm in which tasks are assigned to a combination of connections, software and services accessed over a network. This network of servers and connections is collectively known as “the cloud.” Computing at the scale of the cloud allows users to access supercomputer-level power. Using a thin client or other access point (e.g., an iPhone, laptop, or BlackBerry), users can reach into the cloud for resources as they need them. For this reason, cloud computing has also been known as “on-demand computing.”

This vast processing power may be made possible though distributed, large-scale cluster computing, often in concert with server virtualization software (e.g., Xen) and parallel processing. Cloud computing can be contrasted with the traditional desktop computing model, where the resources of a single desktop computer are used to complete tasks, and an expansion of the client/server model. Like grid computing, cloud computing may require the use of software that can divide and distribute components of a program to thousands of computers. Cloud computing allows users and companies to pay for and use the services and storage that they need, when they need them and, as wireless broadband connection options grow, where they need them. Customers can be billed based upon server utilization, processing power used or bandwidth consumed. In such a manner, data centers and their administrators may be put at the center of the distributed network, as processing power, electricity, bandwidth, and storage may be easily managed remotely.

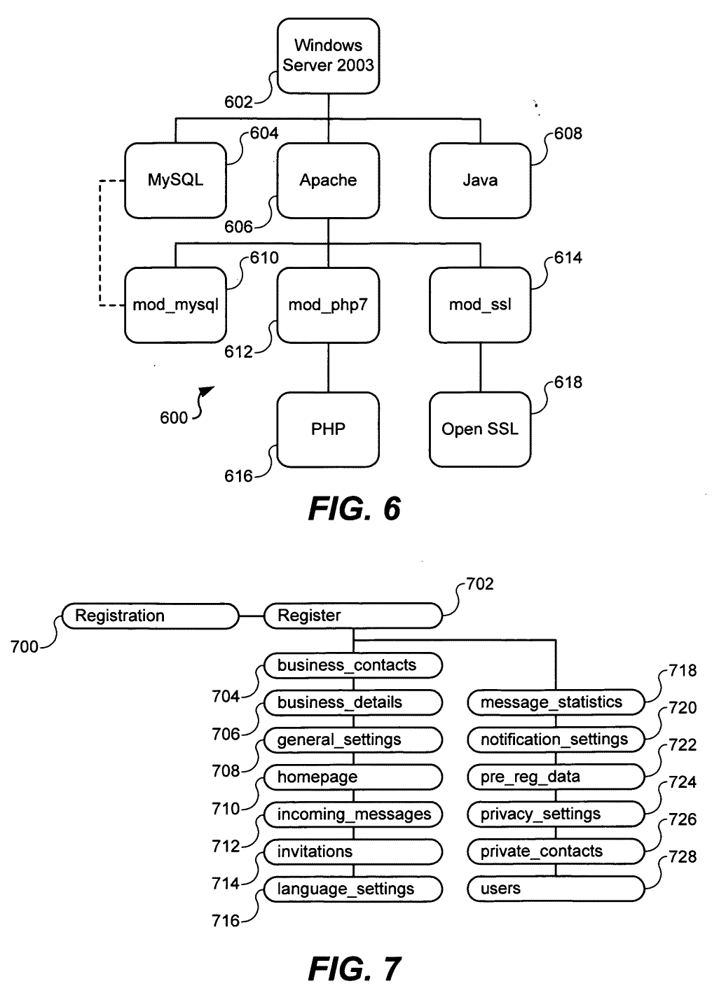

In exemplary embodiments of the present invention, platform software compatibility for application 106 is shown in FIG. 6.

Referring now to FIG. 7, the main task of Registration Module 700 is to handle several types of user registrations. Registration Module 700 creates user accounts with specified account credentials. It may be processed over a secure, 256-bit-key encrypted connection, through use of a Register module class 702, and database tables 704, 706, 708, 710, 712, 714, 716, 718, 720, 722, 724, 726, and 728. After successful registration, the member profile can be viewed by other member users.

According to an exemplary embodiment of the present invention, there may be four types of registration: (1) a standard registration; (2) registration from an invitation; (3) registration from a promotional campaign; and (4) pre-registration. Standard registration typically involves situations in which: (a) the registering user has not been invited to the portal by any existing iMedicor member and his e-mail cannot be found in iMedicor member databases; (b) the registering user has not entered any promotional code during registration; or the registering user has not been pre-registered by a medical association, healthcare institution, or other organization. Registration from an invitation typically involves situations in which registering users have been invited by an existing member whose e-mail address has been entered during the registration process and can be found in a member database. Registration from a promotional campaign typically involves situations in which a registering user has entered a valid promotional code during the registration process. Finally, pre-registration typically involves situations in which registering users have been pre-registered by a medical association, healthcare institution, or other organization.

Registrations of the first two types may share the same initial settings. Users may be added to a default group/groups, and default contacts may be added. Default settings for users with registrations of the last two types may be different based on the promotional campaign or the organization that pre-registered them.

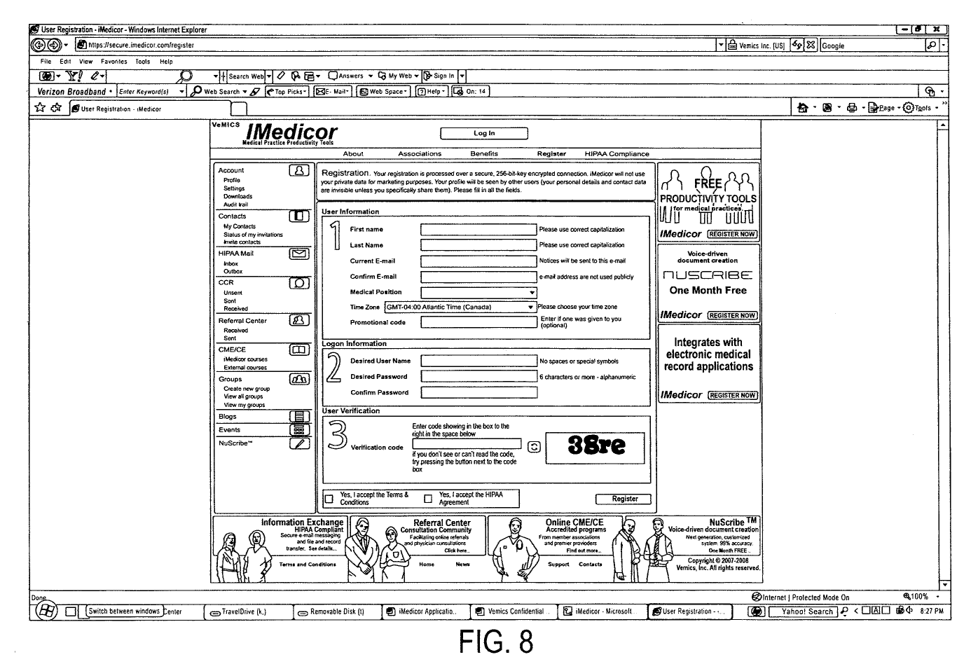

During the registration process as shown in FIG. 8, registering users may be asked to provide their: (a) first and last names; (b) medical title (in which additional information may be required for some positions); (c) e-mail address; (d) desired username and password; and (e) promotional (optional) and verification codes. It should be noted at this juncture that: (1) registering users must accept certain terms and conditions and a HIPAA agreement; (2) the registering user's e-mail address must be unique and not used by any other registered user; and (3) the registering user's desired username must be unique and not used by any other registered user.

If the registration form is completed correctly and has passed data validation, registering users receive an e-mail with a unique link to validate their e-mail address and activate their account. If any data is entered incorrectly or omitted, an error message is displayed. All accounts may stay inactive until validation has been completed.

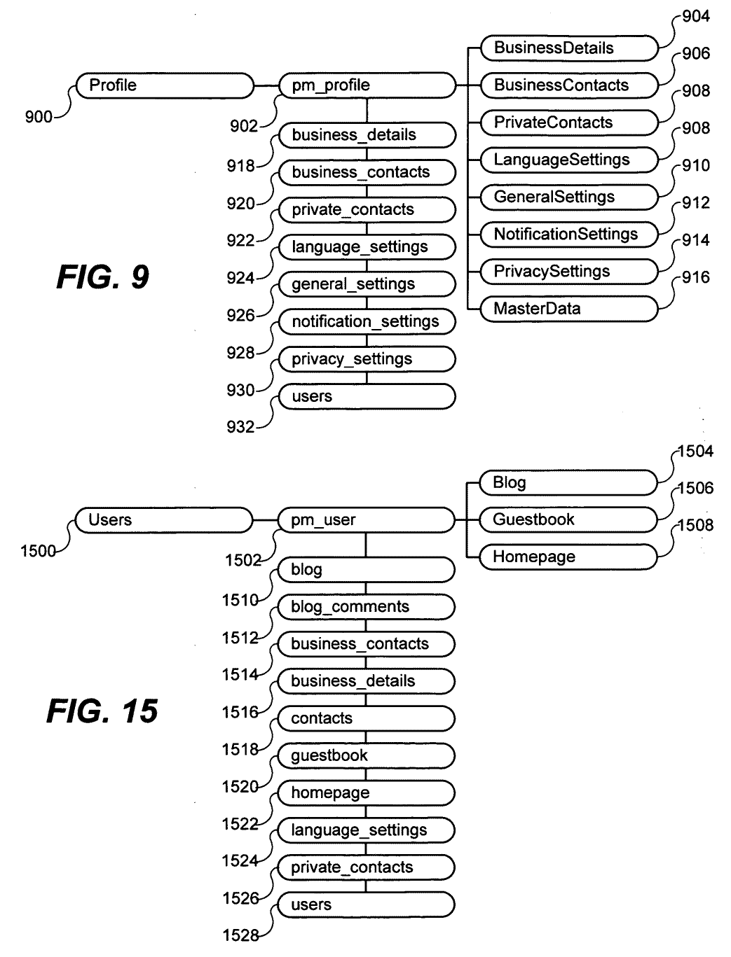

As shown in FIG. 9, the main task of the Profile Module 900 is to make member account information updates possible. Profile Module 900 comprises module classes 902, 904, 906, 908, 910, 912, 914, 916, and database tables 918, 920, 922, 924, 926, 928, 930, 932. Depending on the information that needs to be changed, different restrictions, conditions and information formats apply.

Available options in Profile Module 900 include the following:
Change business details
URLs must be entered in correct format
Change business contacts
E-mail and phone and fax numbers should be in correct format
Change private contacts
Homepage and blog URL must be entered in correct format
Upload/Change/Remove photo
File must be in one of following formats: DICOM, JPEG, GIF, BMP, TIFF, PNG
Image should be at least 140×185 pixels in size
File size should be no bigger than 250 kilobytes
Change password
Previous password must be provided
Change master settings
Username must be unique. No two users can share the same username.
Change e-mail notifications
No specific conditions apply

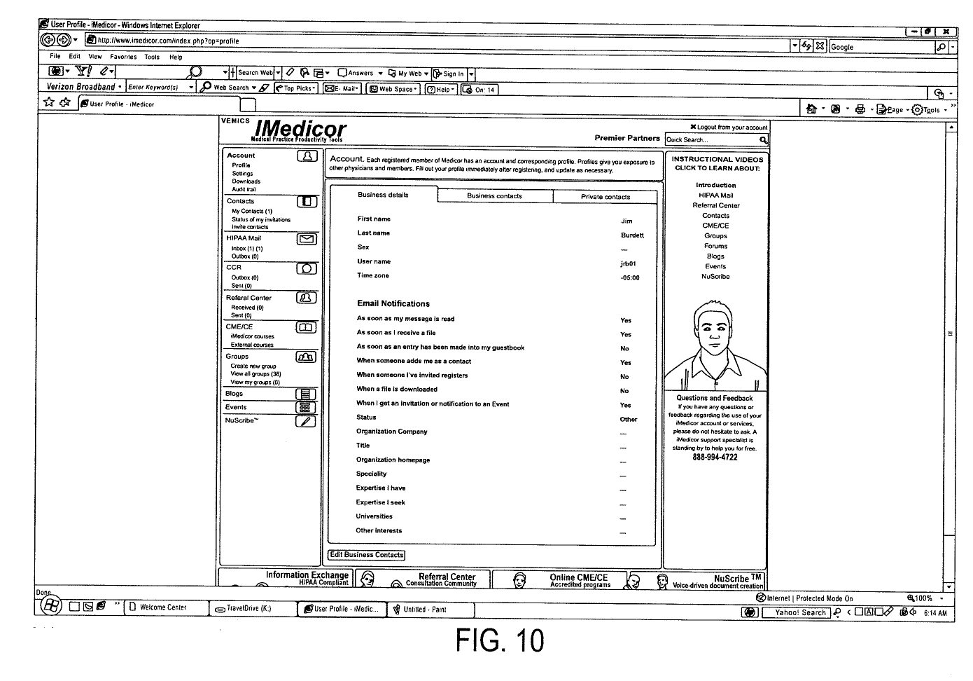

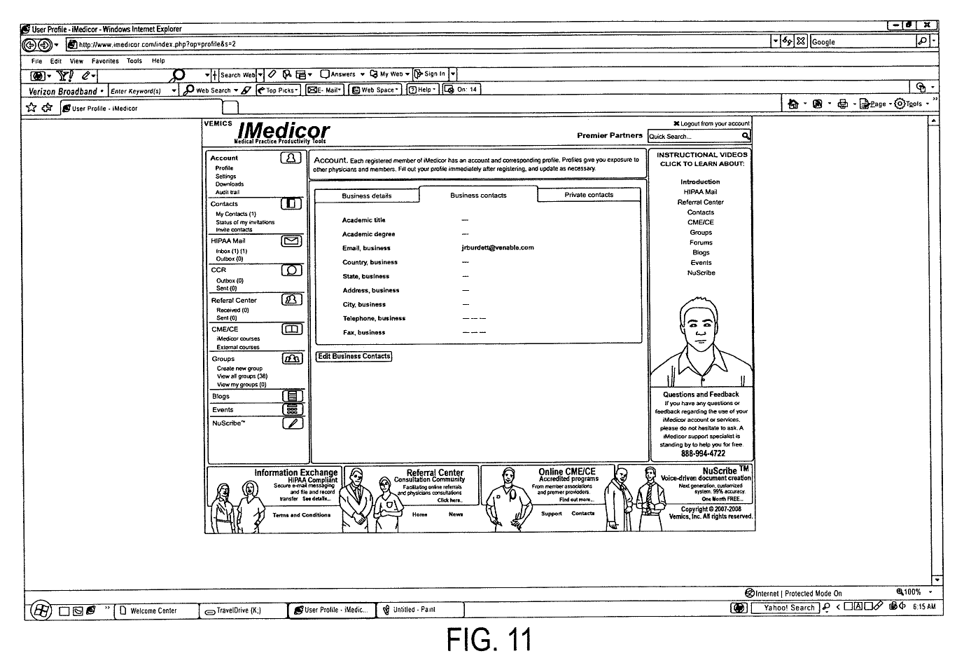

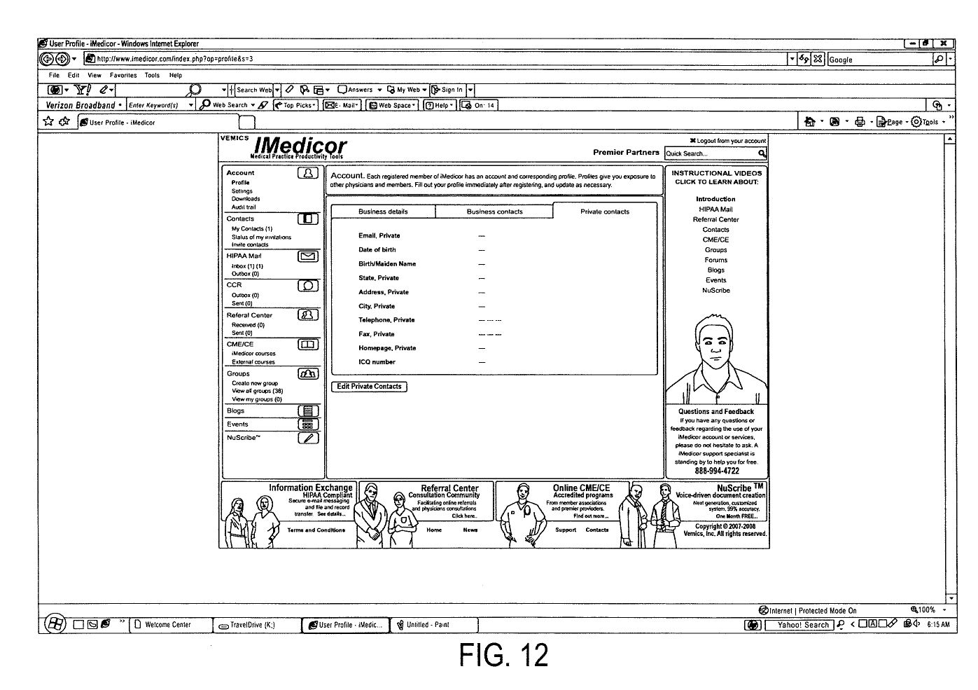

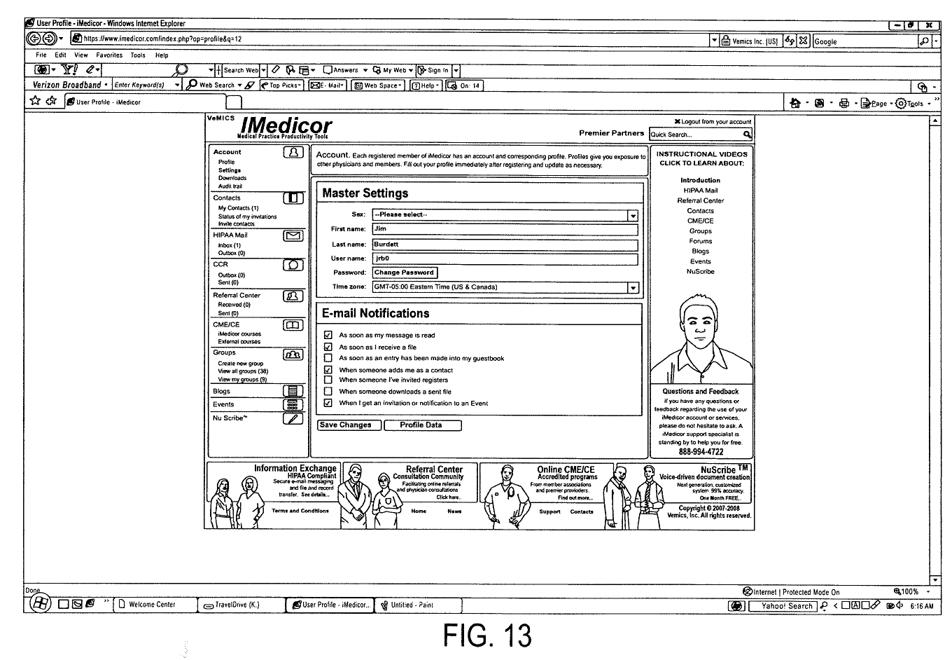

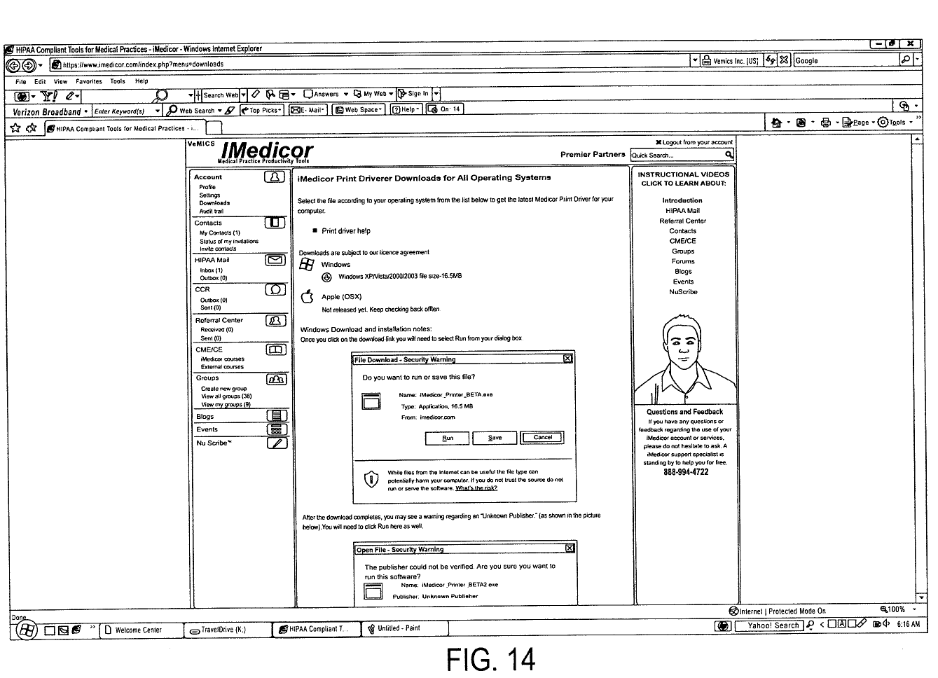

FIGS. 10-12 illustrate web pages which implement Profile Module 900. FIG. 13 illustrates a web page which helps implement Profile Module 900 by facilitating Master Settings, and FIG. 14 illustrates a web page which helps implement Profile Module 900 by facilitating Downloads.

Referring now to FIG. 15, the main task of the Users Module 1500 is to display member specific data to anyone viewing a member's profile, depending on the viewers' login status. Each registered member has an account and corresponding profile. Profiles give exposure to other members. Users Module 1500 comprises module classes 1502, 1504, 1506, 1508, and database tables 1510, 1512, 1514, 1516, 1518, 1520, 1522, 1524, 1526, 1528. Users Module 1500 data includes:
business details
business and private contacts
guestbook
homepage
blog

The amount of information that can be viewed and the functionality that is available differs depending on whether the member viewing the profile has logged onto application 106 or not, if he is in the profile owner's contact list and what privileges the profile owner has set for the member.

Members who have not logged in may see profile in “read-only” mode. Contact details may be hidden, and anonymous posting in guestbook or blogs comment section may not be available. Members who have logged in may leave a guestbook entry and comment on the profile owner's blog. Members who have logged in and is in the profile owner's contact list may see business and private contact details if the profile owner has chosen to disclose them for the viewing member.

The Users Module 1500 includes functionality required to add articles to blogs. The Blog editor is a simple article submission form split into three parts: title, body start (i.e., an introduction chapter) and body (i.e., main article content). To edit a user's homepage, the member uses the Homepage editor, which is a simplified “WYSIWYG” editor with an option to make the homepage private or public.

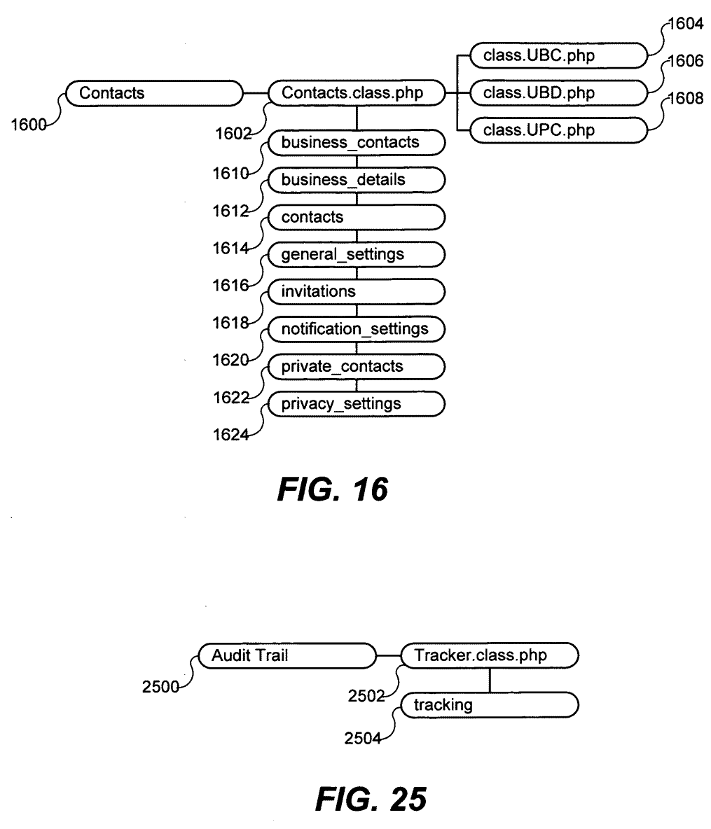

Referring now to FIG. 16, the Contacts Module 1600 according to one embodiment of the present invention will now be explained. Contacts Module 1600 is responsible for managing a member's contacts list. Contacts are those colleagues the member has chosen to include in their personal HIPAA mail network. Because the systems, methods, and computer program products according to various embodiments of the present invention operate on a closed network, members must invite others to become contacts—and they must accept—in order to exchange messages and transfer files with them. If a given member tries to send HIPM messages to any other member who is not in the given member's contacts list, they will be added to the given member's contacts list automatically and will receive the given member's message only after the other members confirm the given member as a contact.

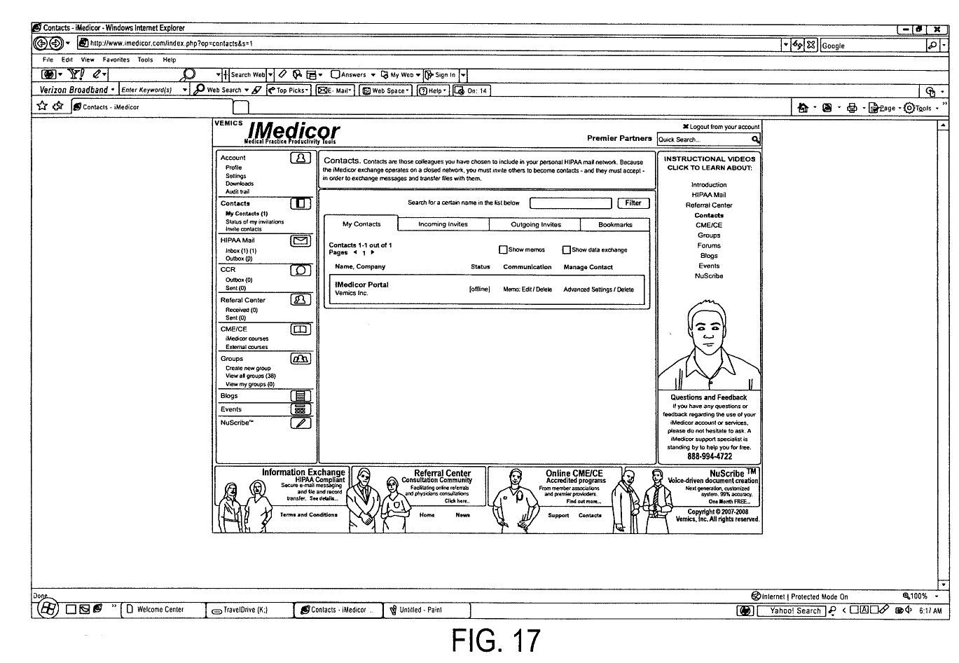

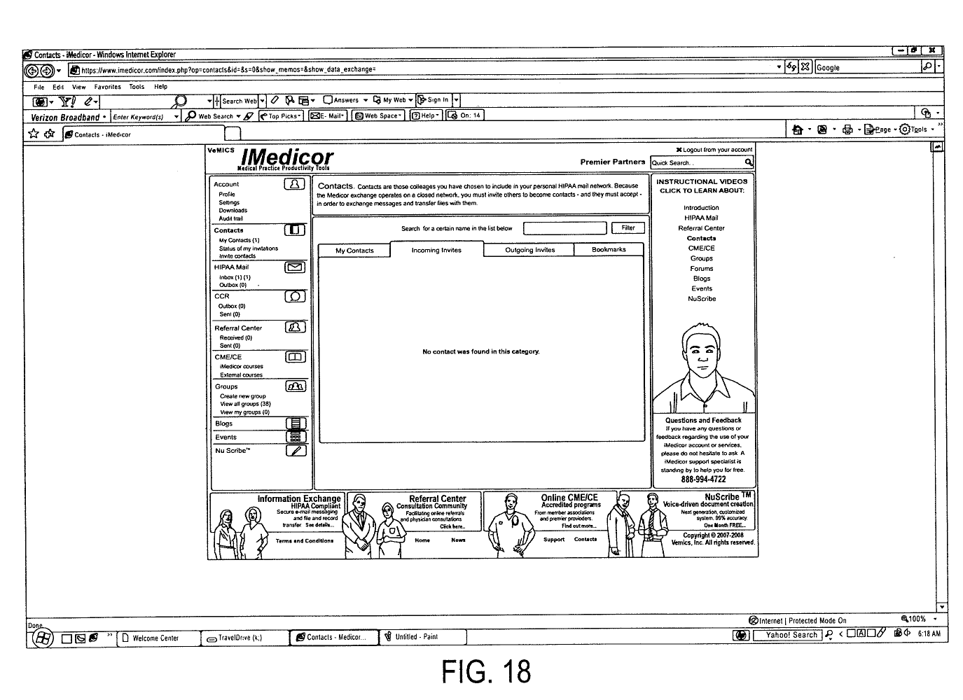

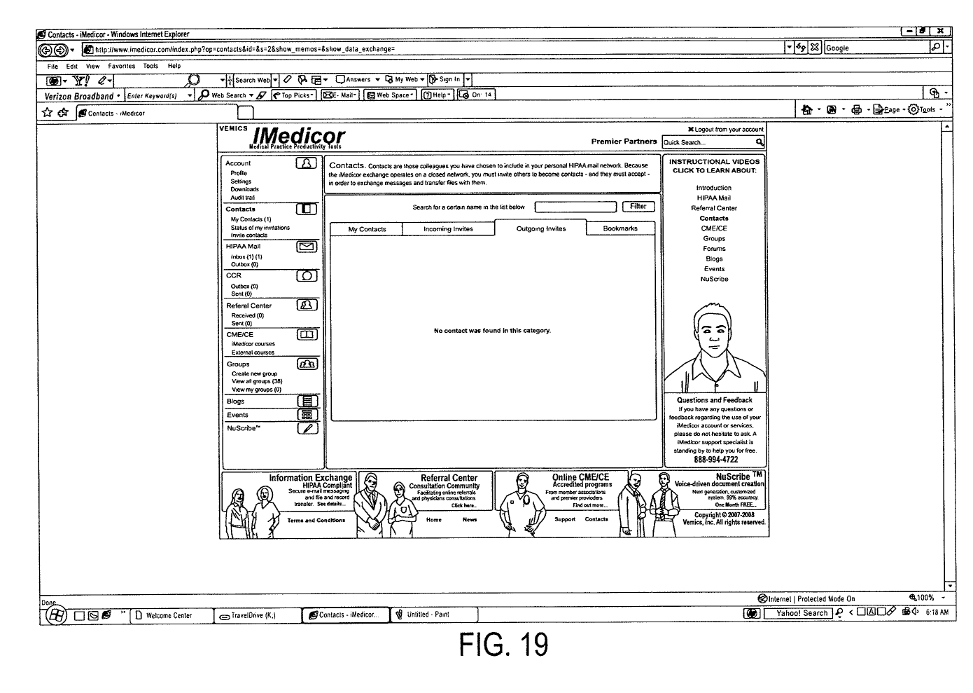

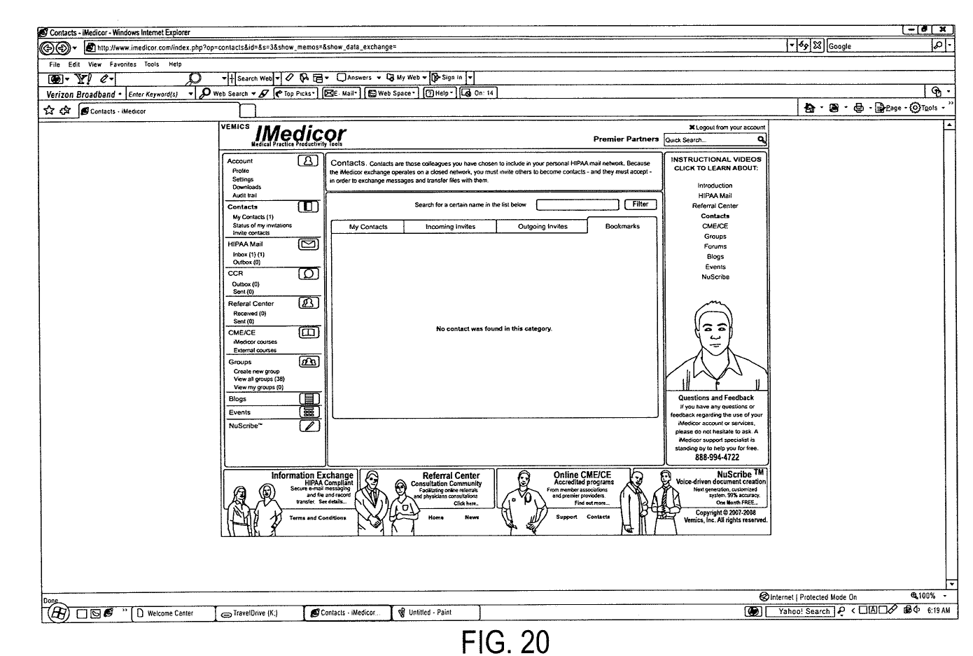

Contacts Module 1600 comprises module classes 1602, 1604, 1606, 1608, and database tables 1610, 1612, 1614, 1616, 1618, 1620, 1622, 1624. The primary features of Contacts Module 1600 includes:
My Contacts (which is the list of people a member has added as contacts and who have added that member as a contact too). FIG. 17 depicts a web page which helps implement the My Contacts feature according to the Contacts Module shown in FIG. 16.
Incoming Invites (which is the list of members who have added a specific member to their contact lists and have asked that member to add them as a contact too). A member may decide whether to accept or deny the request. FIG. 18 depicts a web page which helps implement the Incoming Invites feature according to the Contacts Module shown in FIG. 16.
Outgoing Invites (which consists of members a given member invited to be added to his contacts list but who have not accepted the invitation). FIG. 19 depicts a web page which helps implement the Outgoing Invites feature according to the Contacts Module shown in FIG. 16.
Bookmarks (which is a link to find members quickly, if needed, who are not in a member's contacts list). FIG. 20 depicts a web page which helps implement the Bookmarks feature according to the Contacts Module shown in FIG. 16.

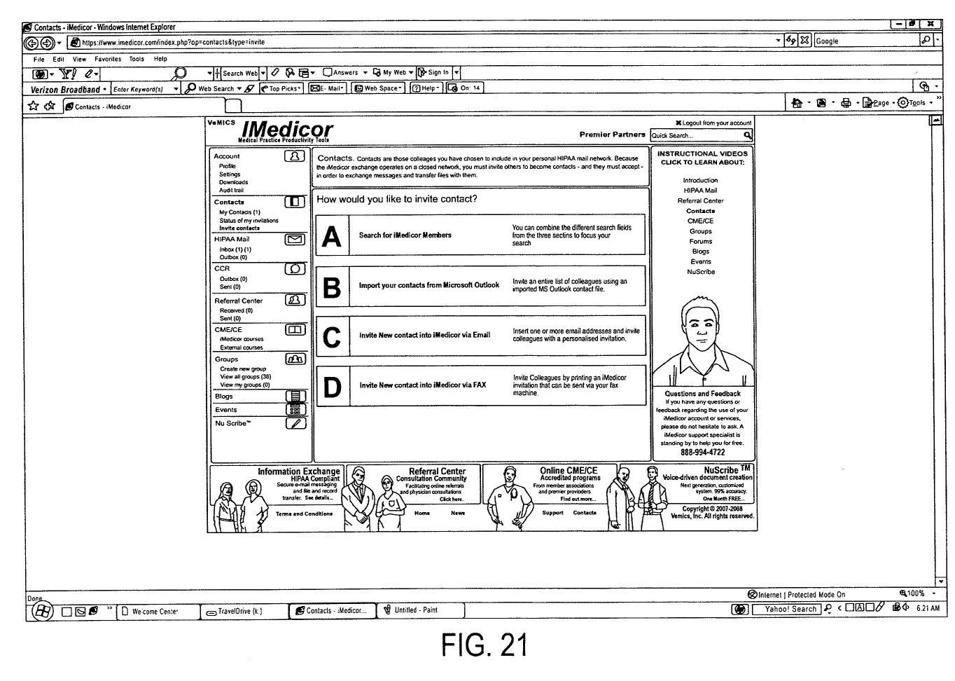

Referring now to FIG. 21, it can be seen that members may use the Invite feature in the following manner. This feature is used to invite friends to register as members and have an opportunity to exchange HIPAA messages using the Invite feature in Contacts Module 1600. There are three types of invitations: (1) import from Microsoft Outlook; (2) invite via e-mail; and (3) invite via fax.

Before importing from Microsoft Outlook, the member needs to export contacts. Open Outlook Express application. Choose File>Export>Address Book. Select Text File (Comma Separated Values) and click Export button. Click Browse button and type the name of the file to export the address book to. Click Next button to proceed to the Export settings. Make sure First Name, Last Name and E-Mail Address checkboxes are checked and click Finish button. An alert message should confirm that the Export process has completed. Click OK and return to the system to upload the file that the address book was exported to. The script will automatically extract all addresses from this file and ask the member whom to invite.

Members can type in friends' e-mail addresses to invite them to join the system and be added to their Contacts list. After registration is complete, the new member and the inviting member will automatically be added to each other's Contacts lists. Members can also create an invitation, print it and then send it via fax to friends.

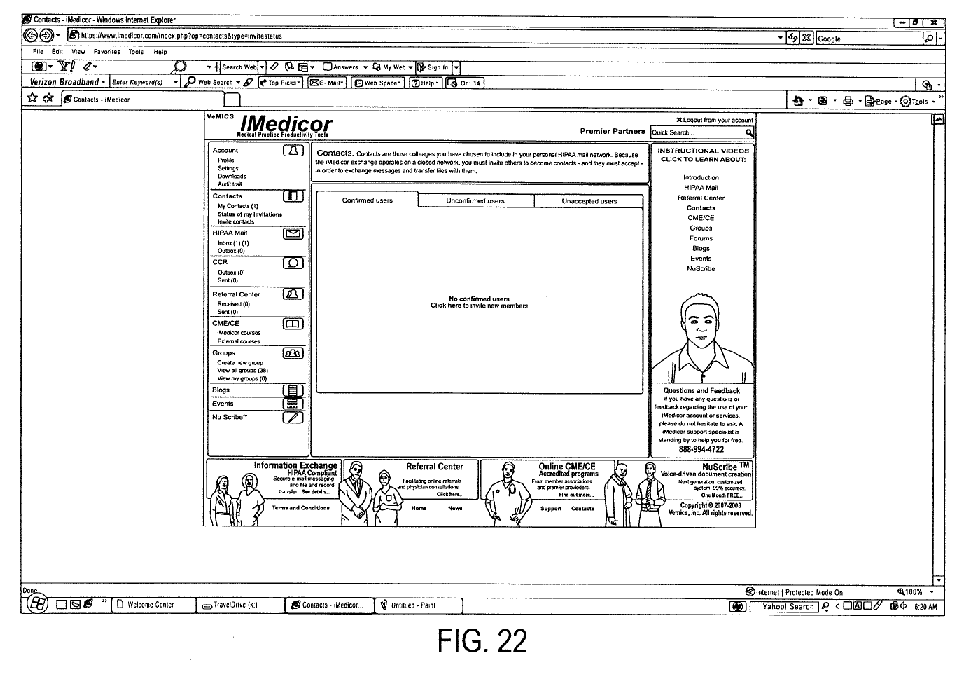

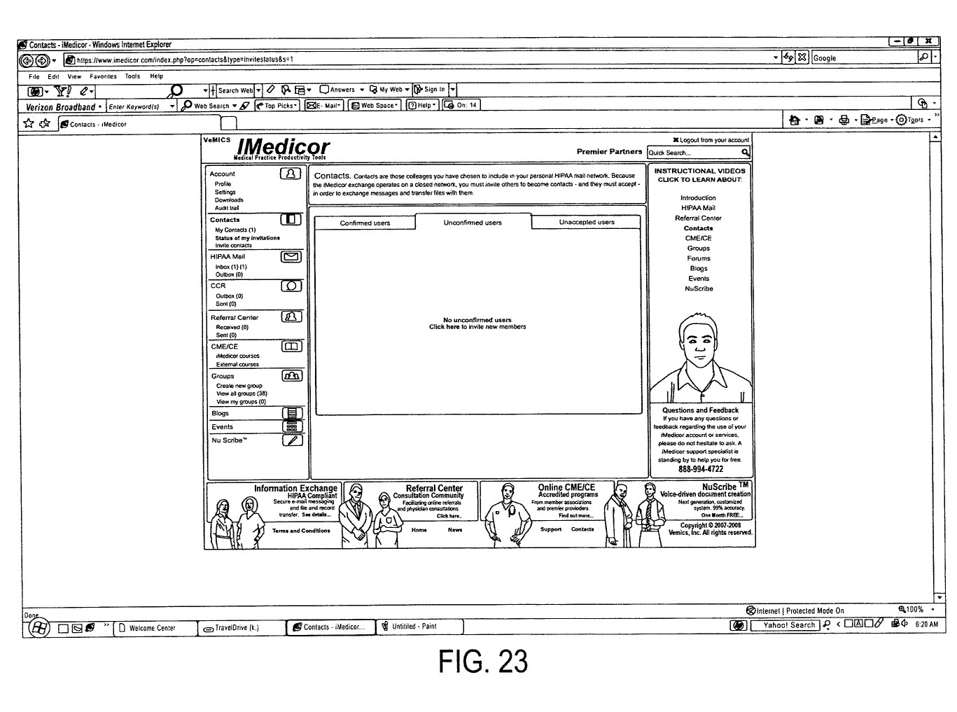

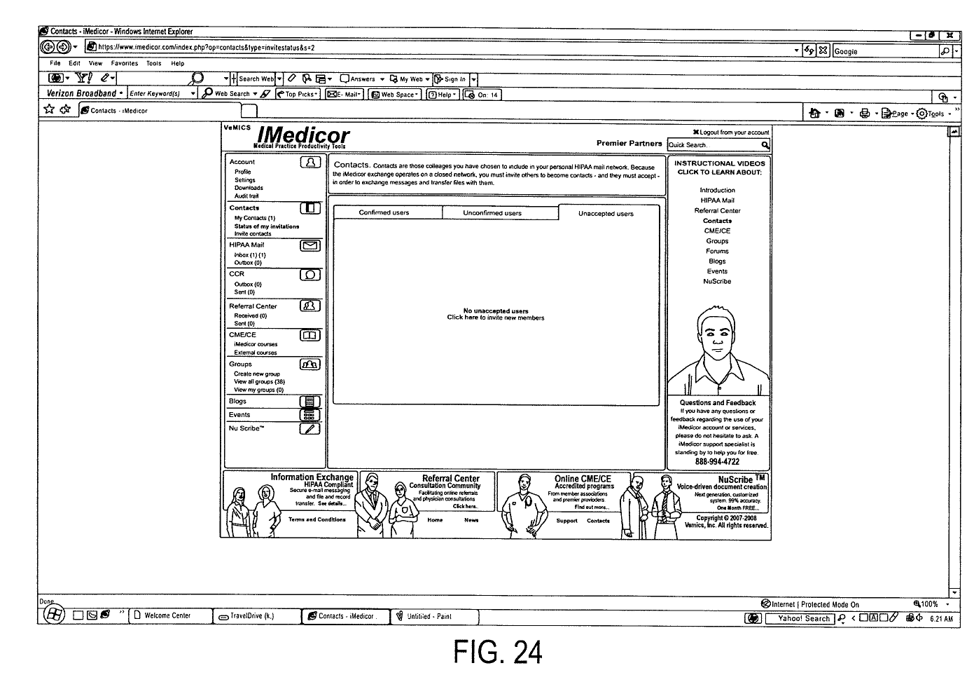

FIGS. 22-24 depict web pages which may be used to further implement the Invite feature for confirmed users, unconfirmed users, and unaccepted users, respectively.

Referring now to FIG. 25, an Audit Trail according to embodiments of the present invention will now be described. The Audit Trail Module 2500 comprises a module class 2502 and a database table 2504. It comprises records showing operations performed during a given period of time, generally a chronological sequence of audit records with details relating to the execution of various functions. Useful for maintaining security, audit trails are required for HIPAA compliance.

Actions which may be stored in an Audit Trail database may comprise:
Login;
Logout;
Changes in user business details data;
Changes in user business contact data;
Changes in user private contact data;
Changes in user general settings;
Changes in user notification settings;
Changes in user privacy settings;
Changes in user master data;
Photo upload;
Password change;
Homepage update;
Sending an invitation;
Contact addition;
Contact removal;
Contact denying;
Contact confirmation;
Sending message;
Message removal;
Forwarding message;
Attached file download; and
Attached file deletion.

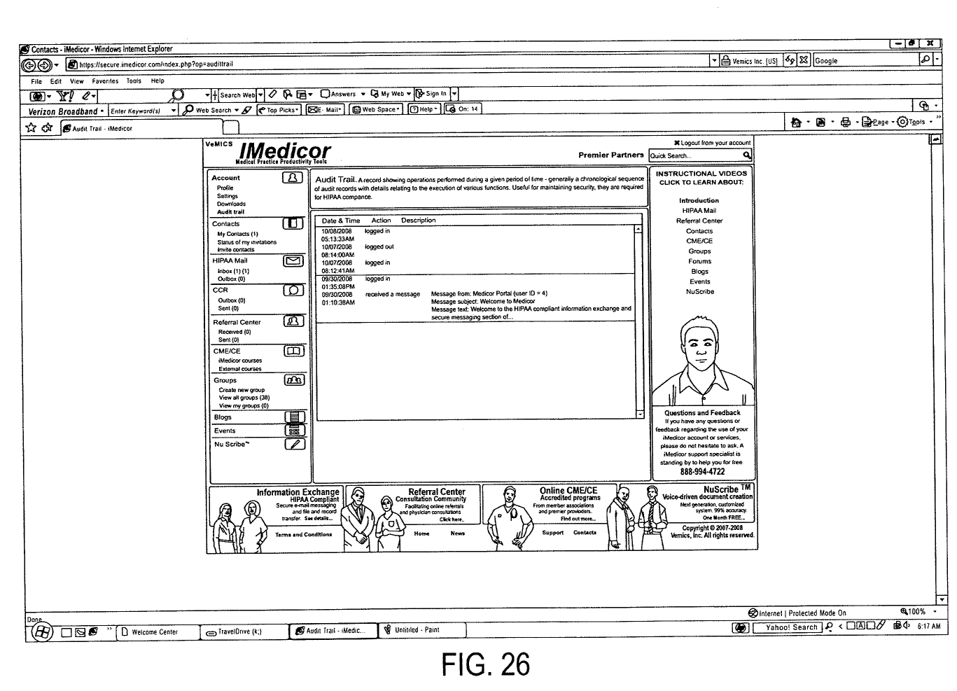

FIG. 26 depicts a web page which may be used to implement the Audit Trail Module shown in FIG. 25.

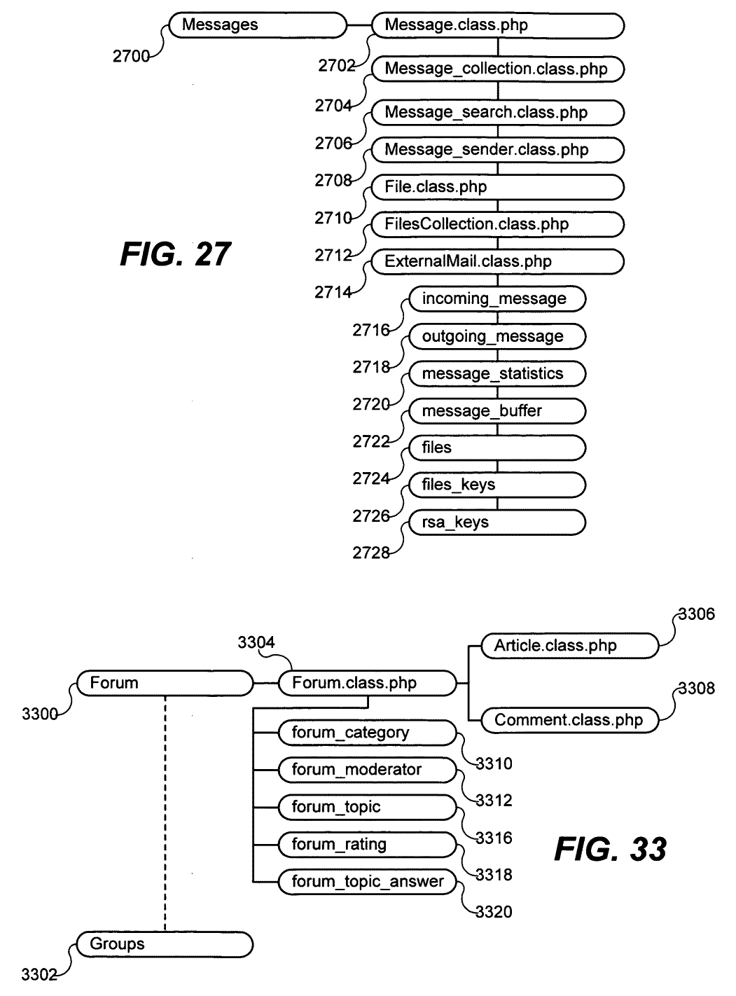

Referring now to FIG. 27, a Messages Module 2700 according to embodiments of the present invention will now be described. The Messages Module 2700 comprises module classes 2702, 2704, 2706, 2708, 2710, 2712, 2714, and database tables 2716, 2718, 2720, 2722, 2724, 2726, 2728. It is designed to give members the ability to exchange HIPAA secure messages and files attached to these messages. All the data in this module may be suitably processed over a secure socket layer (“SSL”) connection between the users' browser and the server. Members may also send messages outside the system to external e-mail addresses. In this case, an invitation is first sent to join the application. The intended recipient will then receive the full message once registration is completed.

Actions available in the Messages Module 2700 may comprise:
Send messages;
Receive messages;
Reply to messages;
Forward messages; and
Send referral messages.

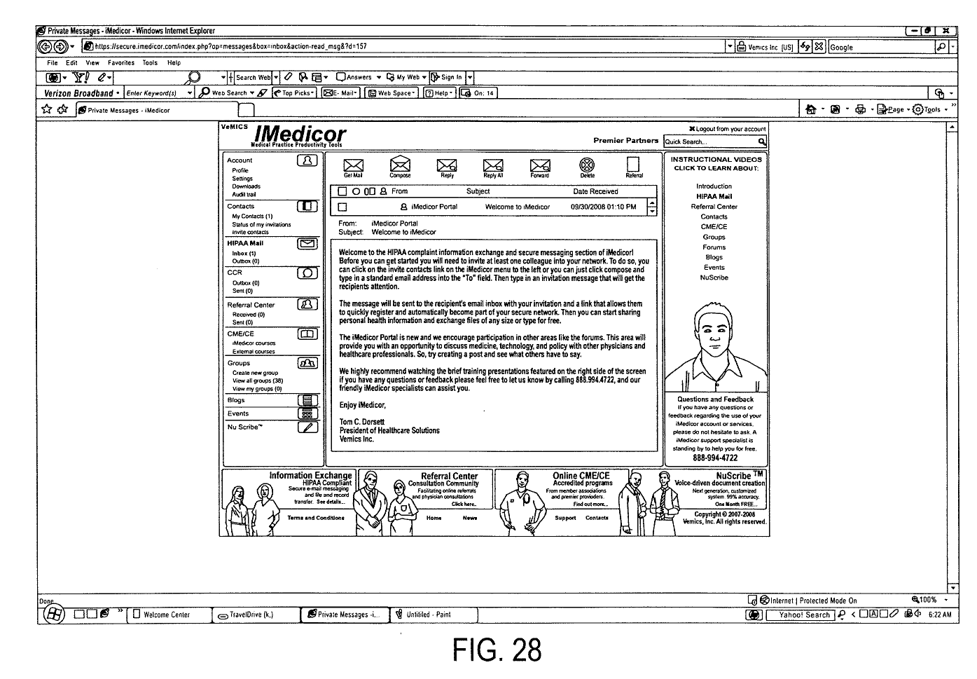

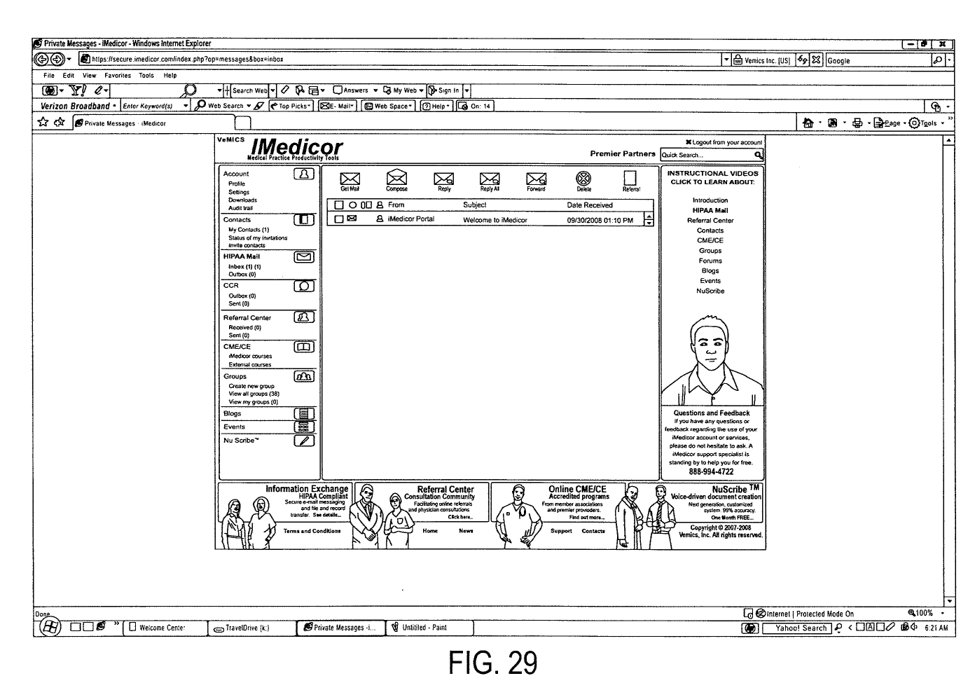

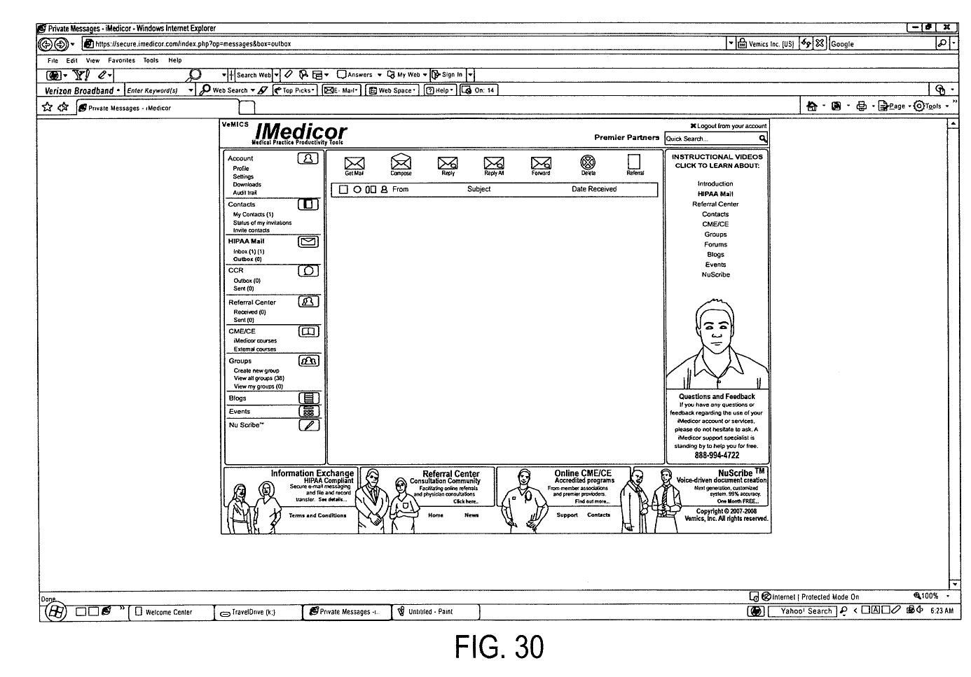

File upload may be processed using a Java applet that creates an SSL tunnel between the applet and file upload Java server. The member's file may then be encrypted with an XOR key, which may be sent to the applet by the server and encrypted with a 1024 bit RSA key. The files stored on the server are encrypted and they are decrypted when the member needs to download a file from the message attachments list. FIGS. 28-30 depict web pages which may be used to implement the Messages Module shown in FIG. 27.

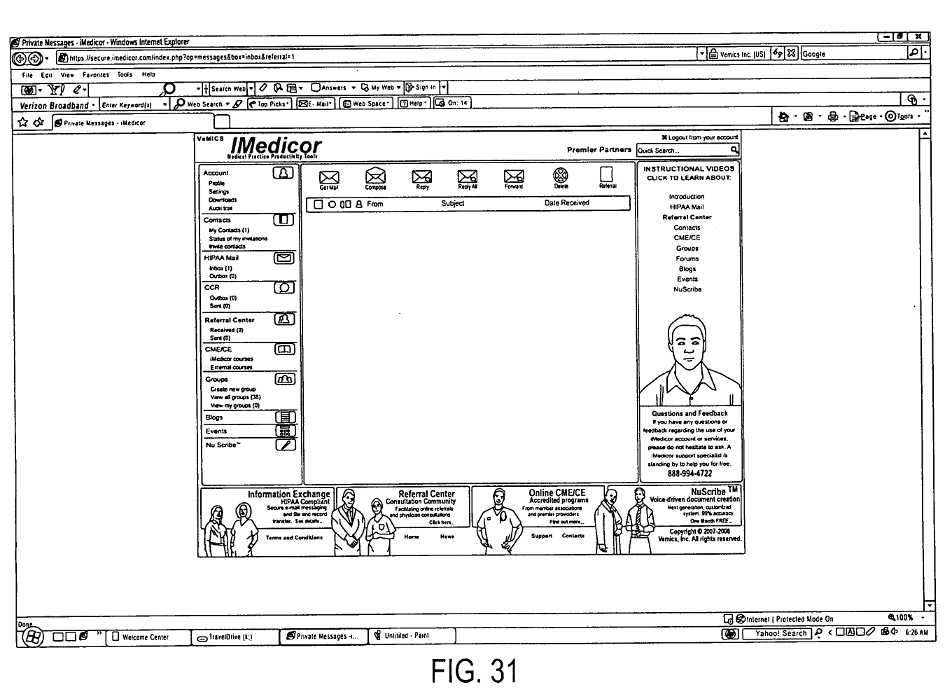

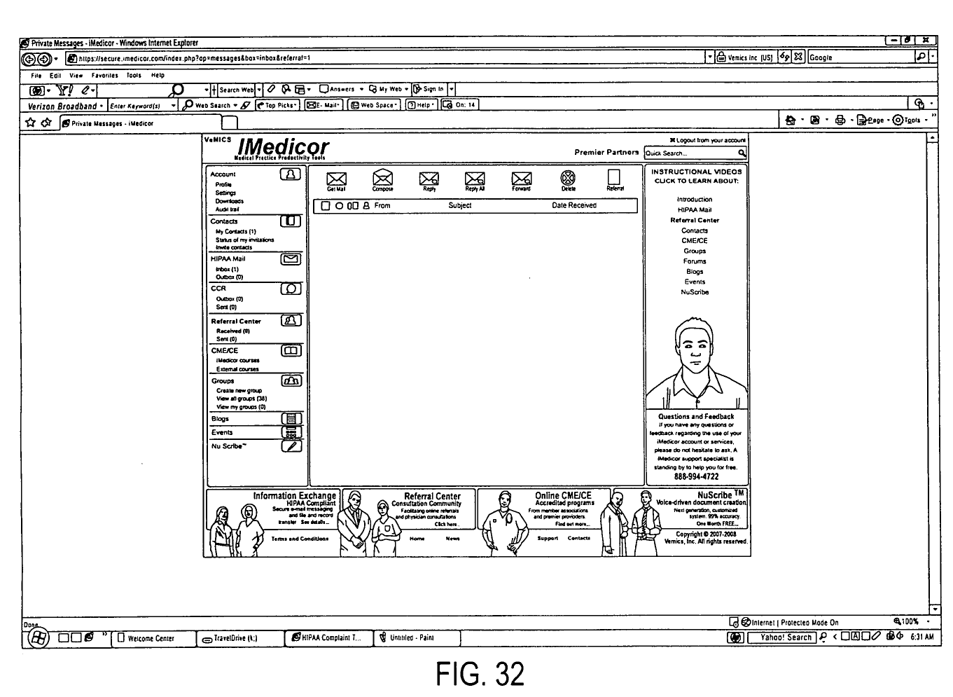

Referral messages are almost the same as ordinary messages, but they have an additional field where the sender can write a patient's name when sending a referral letter. All referral messages (incoming and outgoing) are stored in the Referral Center so they will not to be mixed in with all other messages. FIGS. 31-32 depict web pages which may be used to further implement the Messages Module shown in FIG. 27, particularly for referrals.

Referring now to FIG. 33, a Forum Module 3300 according to embodiments of the present invention will now be described. The Forum Module 3300 comprises module classes 3304, 3306, 3308, and database tables 3310, 3312, 3314, 3316, 3318, 3320. The Forum Module 3300 is designed for group members to post messages on a group board. Group members may add posts and later edit or delete their personal posts. When adding a new post, the member may also edit select design features. The Group's creator is also the moderator of the entire forum and has the ability to delete posts.

Editable design features within the Forum Module 330 comprise:
Set title;
Bold text;
Italic text;
Underscore text;
Quote text;
Add links or email addresses;
Upload picture to server and insert it in a post; and
Preview post before adding to the group board.

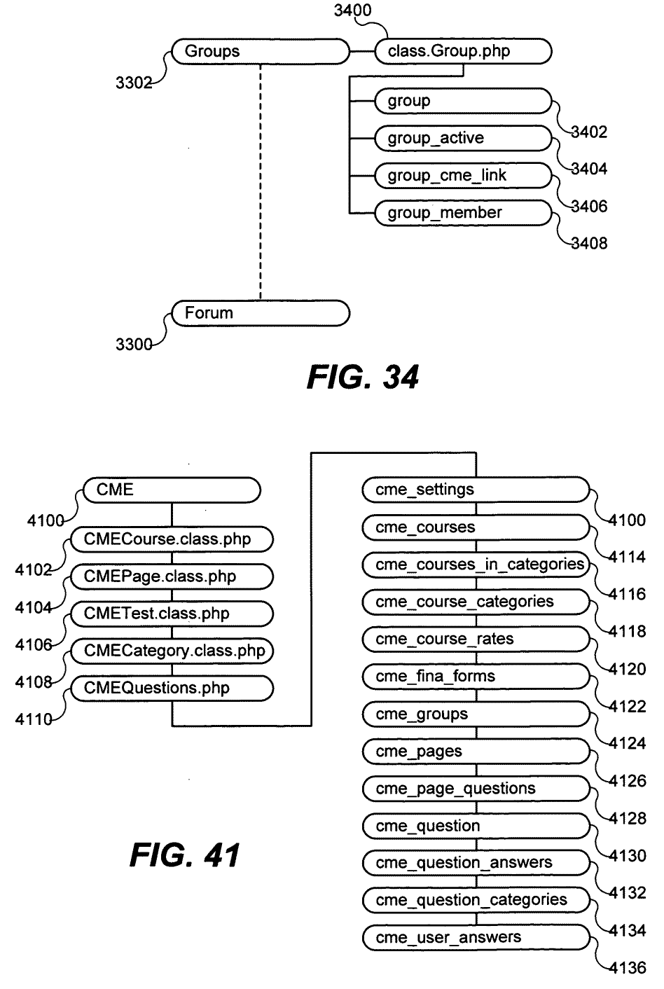

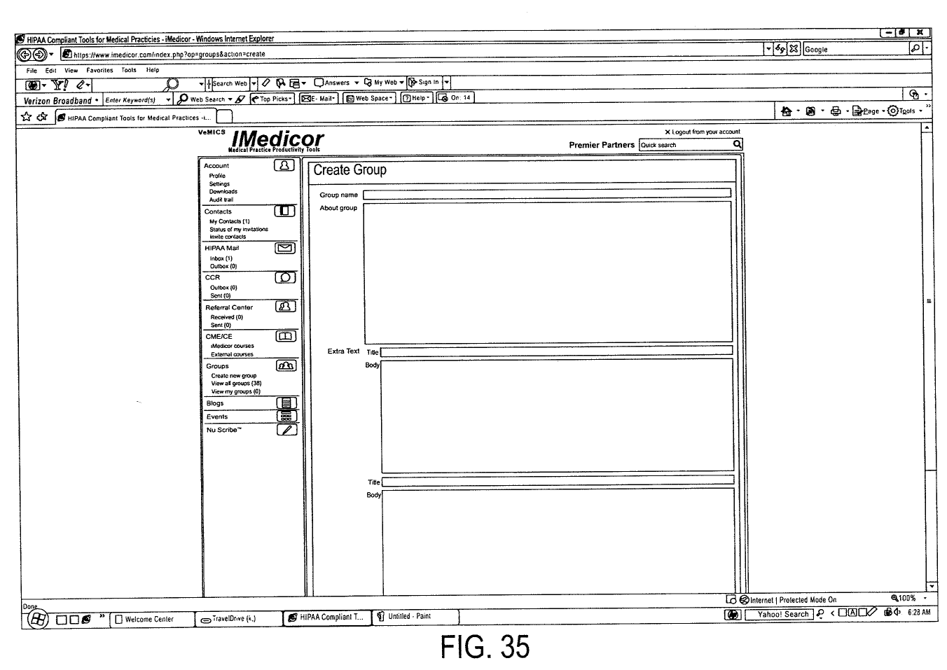

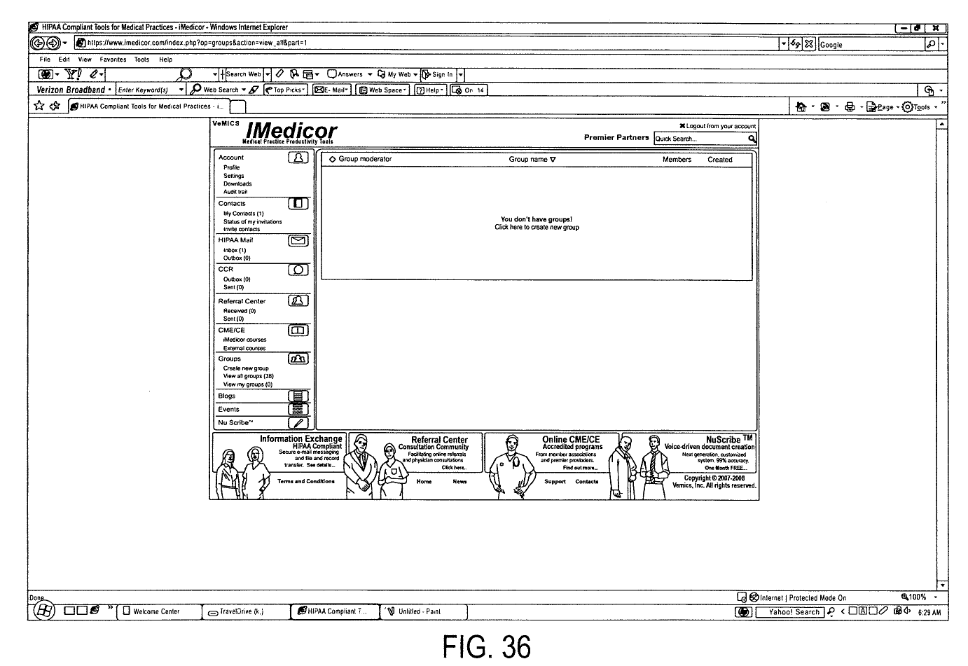

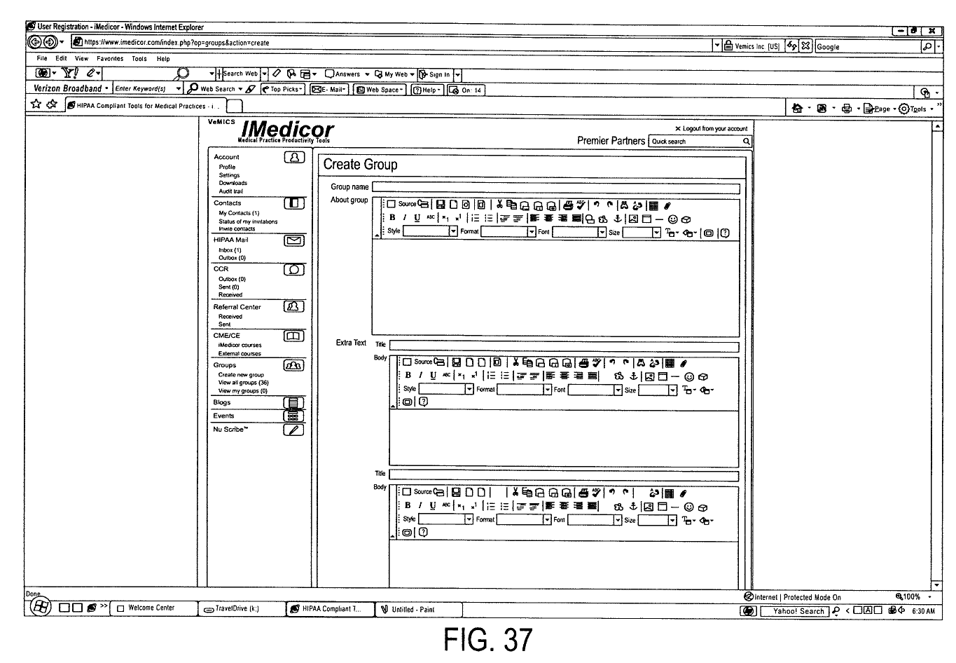

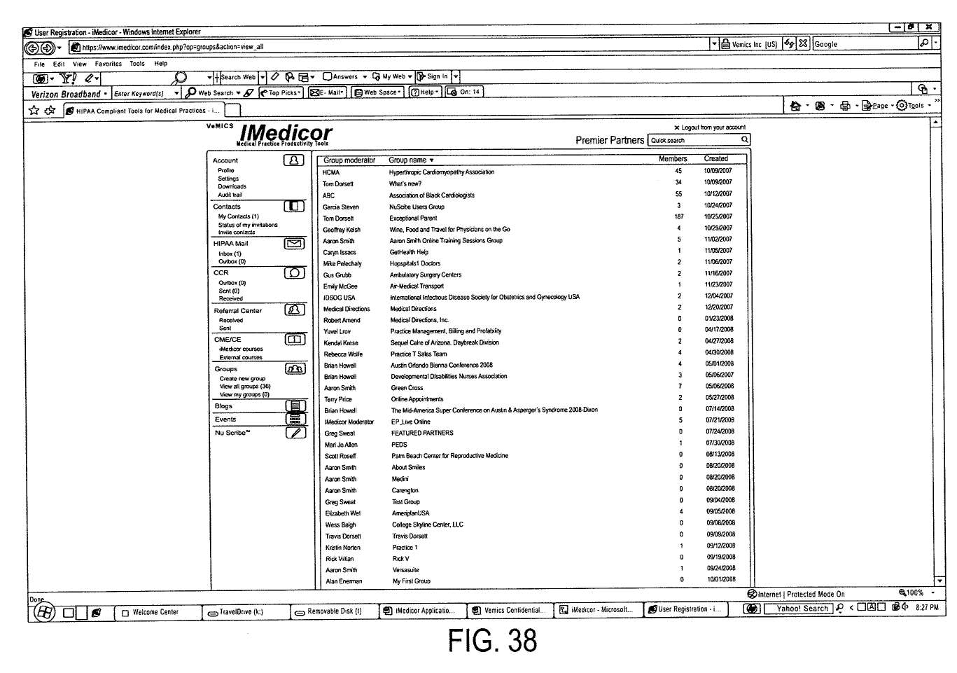

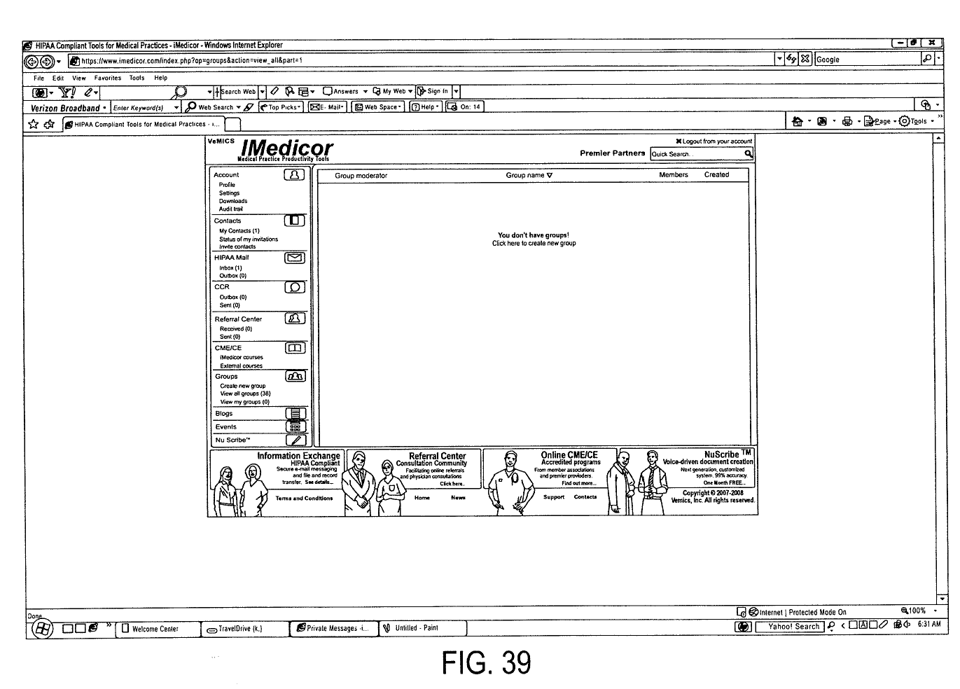

Referring now to FIG. 34, a Groups Module 3302 according to embodiments of the present invention will now be described. The Groups Module 3302 comprises a module class 3400, and database tables 3402, 3404, 3406, 3408. To meet other members, members may access groups. Every group member can create his own group and invite his contact list to become members. Once the group is established, members can search for the group and join it manually. Also, it is possible to create a private group that will not be listed in the public list. However, the group's creator can still share a link to it with members. After a member joins a group, he can choose it as active so it appears as the homepage every time he logs in. When a member creates a group, he becomes the moderator of this group. FIGS. 35-39 depict web pages which may be used to implement the Groups Module shown in FIG. 34.

Within the Groups Module 3302, a group moderator's capabilities comprise:
Add text about the group features a new WYSIWYG editor;
Add up to 2 articles on the group's homepage;
Add a group logo;
Moderate the forum; and
Add one or more links to CME links section.

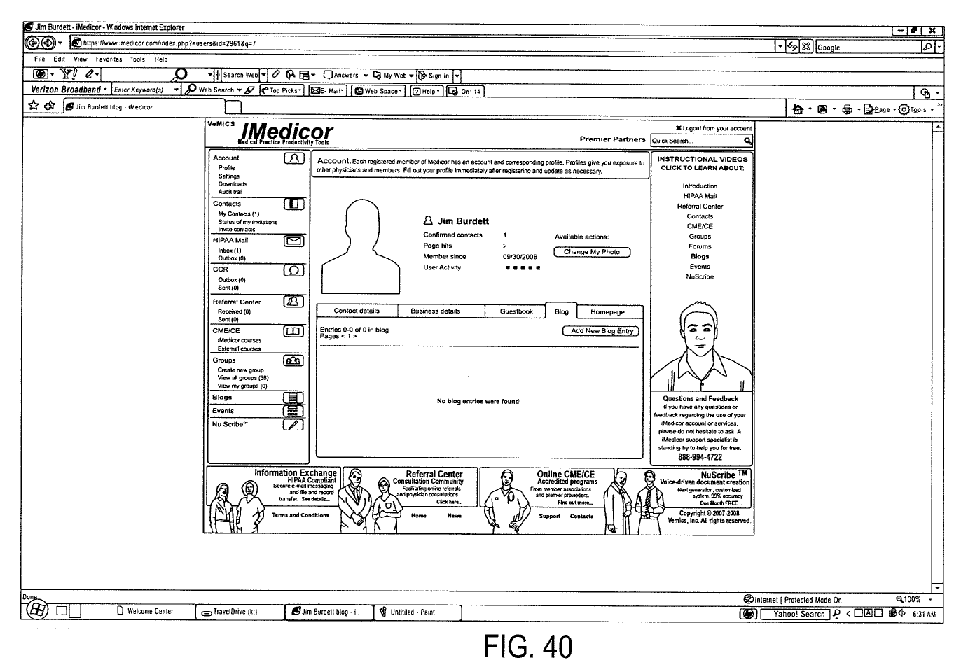

In the blogs section of the Groups Module 3302 as shown in FIG. 40, members can find a list of the latest 25, 50 or 75 personal blog entries of all group members, in order of their addition.

A Continuing Medical Education (CME) Course section in the Groups Module 3302 may be used to allow the group's moderator to create personal links to a collection of different CME courses available in the system.

A Master Forum Module is used as a clone of Forum Module. It brings ability to have a place for every member of the application without need to join a group. Its actual purpose is to help members and answer their questions, and its functionality is the same as the forum module. The difference is in the main page where a list of categories and 2 last posts in this category.

Referring now to FIG. 41, a CME Module 4100 according to embodiments of the present invention will now be described. The CME Module 4100 comprises module classes 4102, 4104, 4106, 4108, 4110, and database tables 4112, 4114, 4116, 4118, 4120, 4122, 4124, 4126, 4128, 4130, 4132, 4134, 4136. It consists of both external and internal modules to provide a place for members to gain access to information about course offerings. Courses are displayed in various categories assigned during the input process. Within a category, the titles are listed according to popularity along with the title, credits and rating (decided by members) of the course. This provides medical professionals easy access to accredited and non accredited information that is vital to his or her practice.

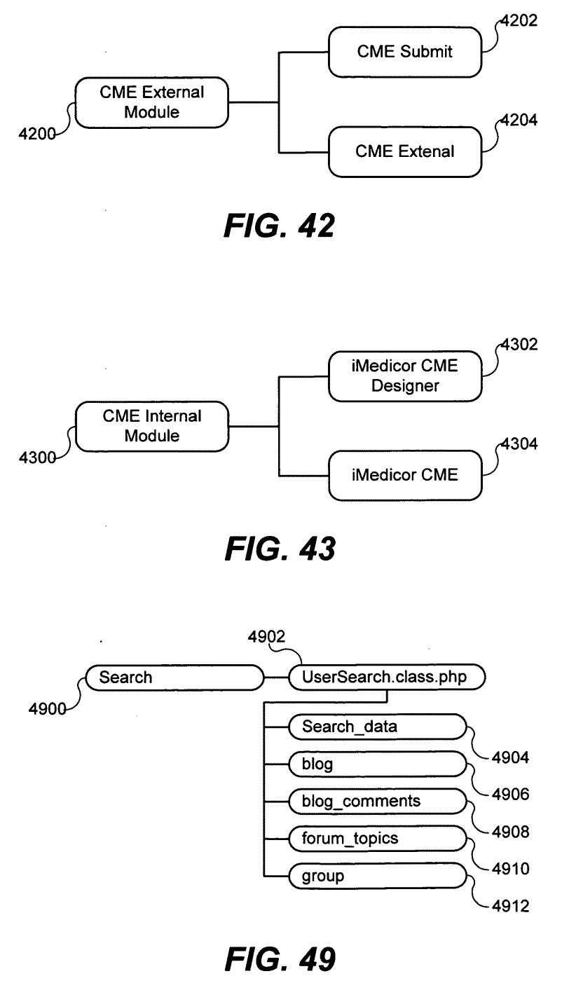

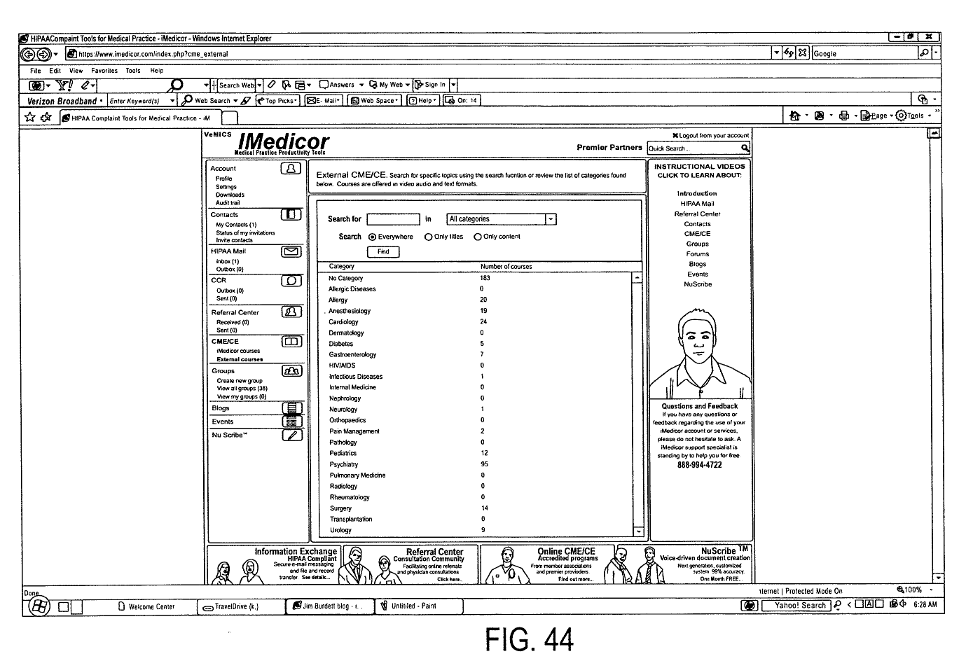

The CME External Module 4200 (FIGS. 42 AND 44) shows all courses available for members that have been located publicly that have been approved for viewing and distribution. Members can search courses by category, title or description and then view a short overview of the selected course. All details in review are the same as were submitted in CME submit except there is also course rating indicator. Every course has its rating that can be set by members after completing course. This helps to show best rated courses at first during the search so user could get best rated courses. Course cannot be rated if user is not logged in or user has already graded the course.

During completing and viewing course there is an “iMedicor” bar on the top of the page. It helps to easily return to the system portal or to search results that were done by user to find this course. Also courses can be rated at the same page.

CME courses that are found publicly are entered into the CME External section using the submit process 4402 which asks for various information about the course. Submitted external CME courses may be passed on to an administrator for approval through this page (FIG. 44) to all or a limited number of members. Courses are submitted using the following parameters:
Title;
Description;
Site Name;
Sponsoring Organization;
Main site URL;
Course URL;
Date range;
Last visited;
Number of credit hours;
Fee;
Last updated;
Primary type of Media;
Text Only;
Text Plus Graphics;
Audio Only;
   Slide-Audio Lecture Format;
   Video Lecture Format;
   Slide-Audio-Video Format;
   A Presentation of Guidelines; and
   Interactive Category; and
Category.

The Administration panel is used to view, edit and manage all courses submitted by members for posting to the site. As soon as a course is approved for posting it becomes visible in the CME External Module 4200.

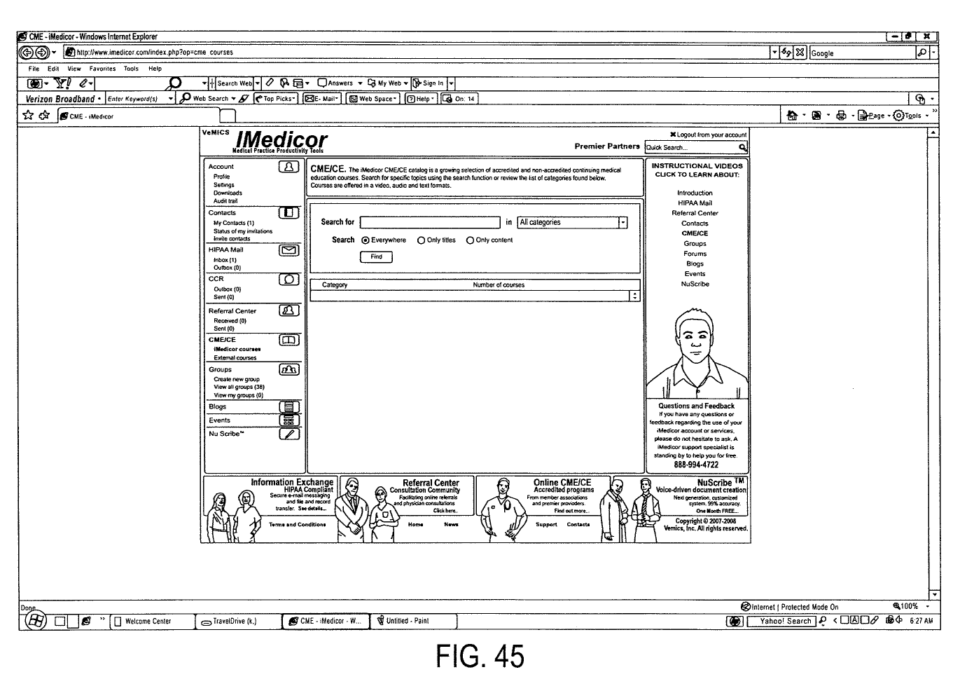

Referring now to FIGS. 43 and 45, the CME Internal Module 4300 will now be explained. An iMedicor CME Designer Module 4302 is used to create courses that can be distributed by members. Every course consists of general information and pages that contain data or question/quizzes. After a course is created, its status will be changed from inactive to active and it will be available in the iMedicor CME internal course list.

The types of general information which may be maintained within the CME Internal Module 4300 comprises:
Course title—appears during search as main title
Course category—course can be found by category
Course description—can be seen before starting the course
Course status
   Inactive—course cannot be seen in iMedicor CME
   Always active—course can be found and is not limited by dates
   Date active—course availability is limited by start and end date

All CME questions may be created in their own pages and can be categorized.
Page text. Course page can be edited using built in HTML course designer. Most features simulate editors like Microsoft Word and Open Office Writer.
Page questions. Add questions to any page so members can check his/her knowledge.
   Multiple choice—right answer consist of multiple selected options
   Single choice—only one option is right

The iMedicor CME Courses Module 4304 works similar to the External CME module. Members browse courses by categories or make search queries by title or description. Courses consist of pages created in CME Designer. Members are asked to rate courses upon completion. Members can view the list of courses he has completed and the date passed, attempt number and the total amount of credits that he received.

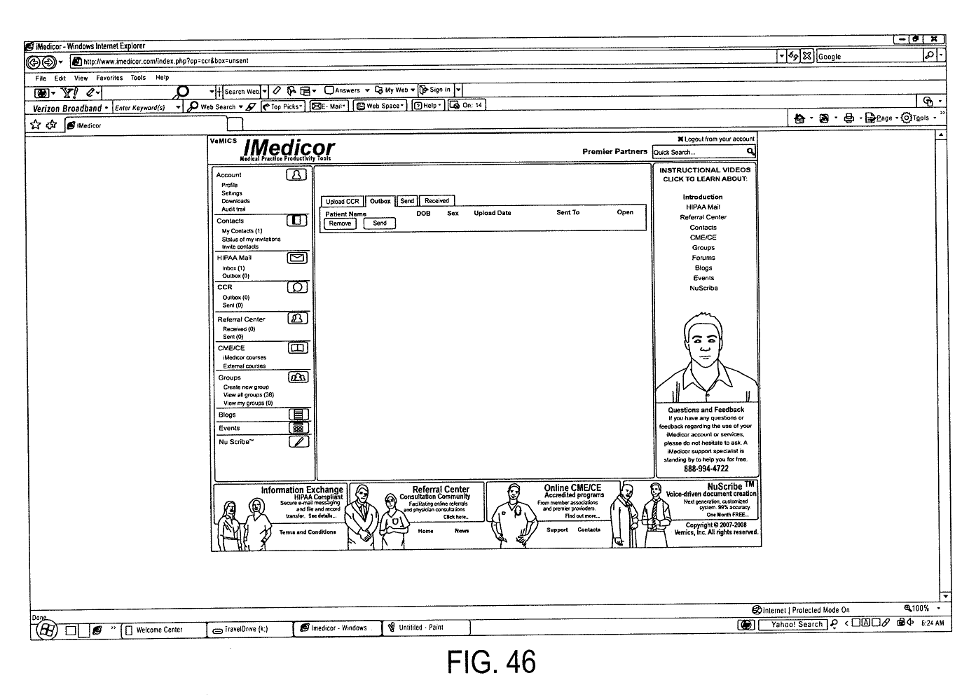

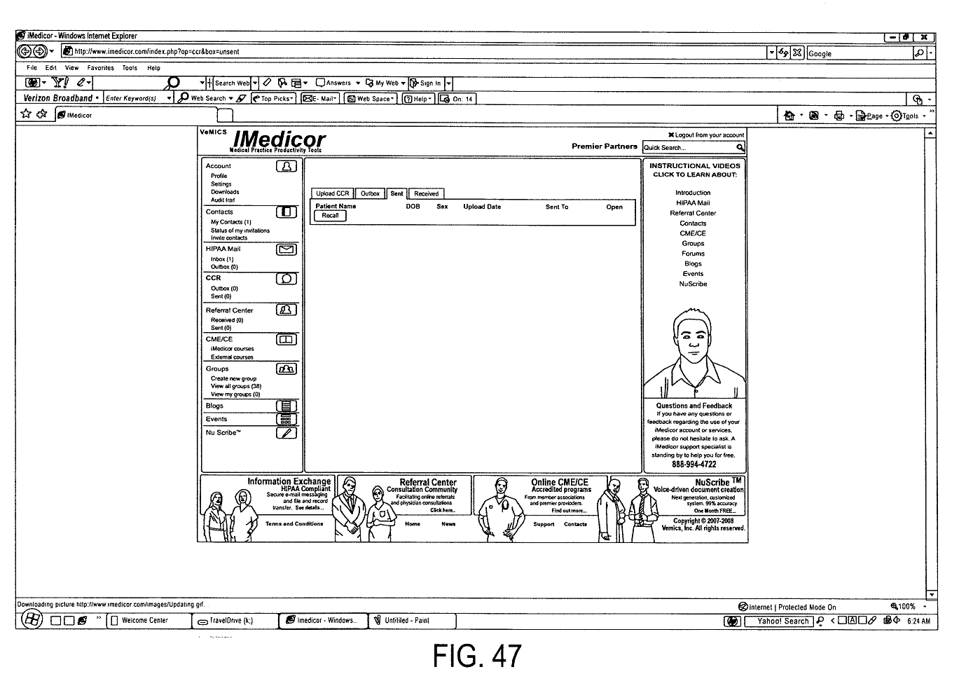

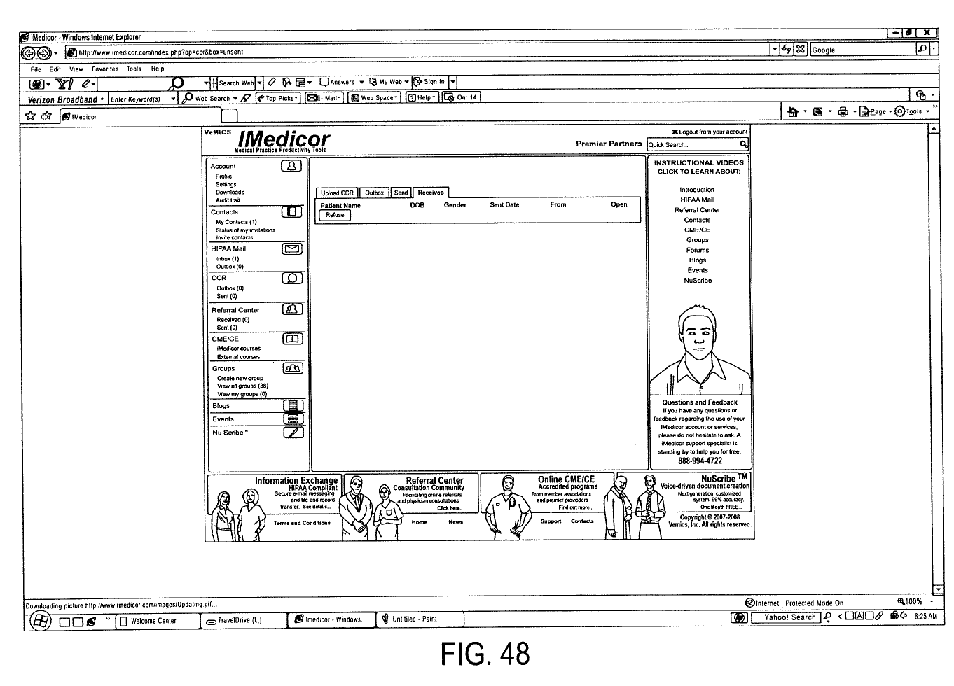

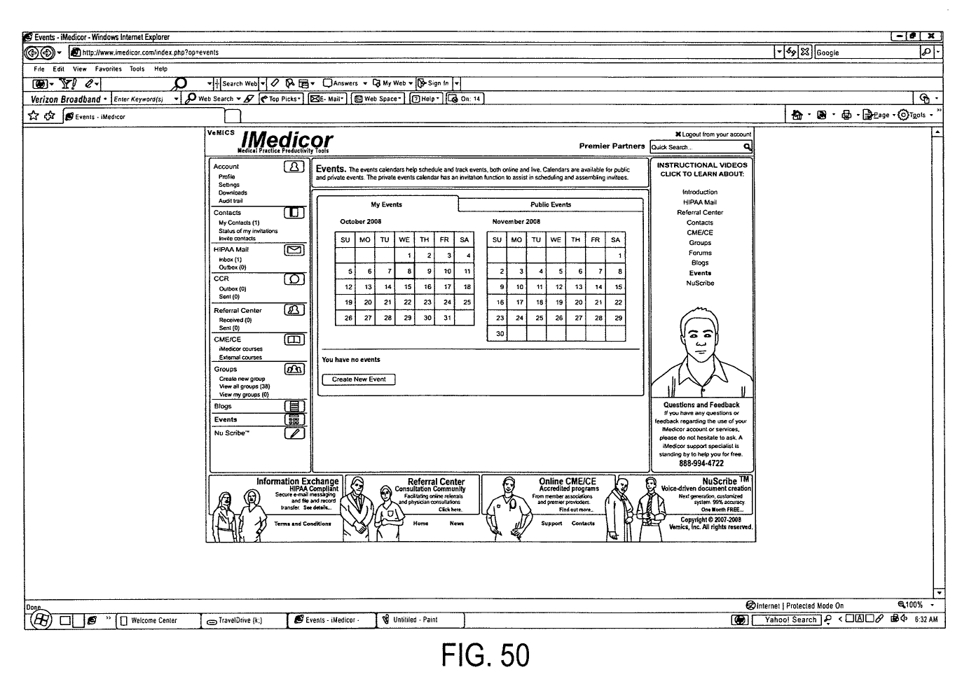

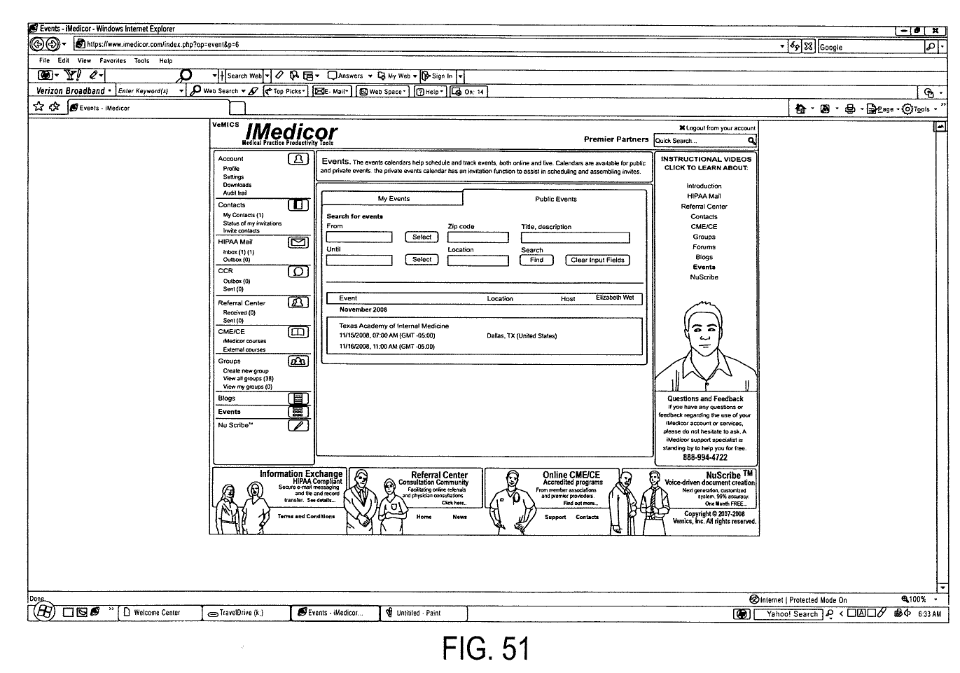

Using the web pages shown in FIGS. 4648, members can enter patient records and send them to other healthcare professionals (e.g., see the send button on the web page shown in FIG. 46), recall the referrals (FIG. 47), or refuse those that may be sent to them by other members (FIG. 48). These tools help ensure that continuity of care records (“CCR”) are safely and securely sent in a HIPAA-compliant manner.

Referring now to FIG. 49, the system's Search Module 4900 will now be explained. Using the system's quick search function, members can find other relevant members, blog entries and comments, groups and group forums. The Search Module 4900 also supports an advanced search mode that combines the different search fields from the three sections to focus a search. To optimize the advanced search execution time and increase the search speed greatly, the database 108 has a table (search_data) where all member data is kept, so there is no need to query from several different tables when searching for members.

Search Module 4900 comprises a module class 4902, and database tables 4904, 4906, 4908, 4910, 4912. Advanced search allows a member to find relevant portal users by:
First name
Last name
Medical school
Interests
Organizations
User status
Company
Specialty
Title
Expertise user has or seeks
City
Country
Zip code
State

As noted above, the Health Insurance Portability and Accountability Act (HIPAA) of 1996 was enacted in 1996. The original intent of HIPAA was to make it easier for people to move from one health insurance plan to another, whether due to job change, unemployment, change in marital status, or the like. HIPAA regulation includes the Administrative Simplification Title (II), which sets requirements in the areas of Transactions, Identifiers, Privacy, and Security. Tied into these legislative requirements are compliance dates and penalties for violations.

In compliance with the Security Rule, systems, methods, and computer program products according to the embodiments of the present invention will follow measures to:
Implement administrative, physical, and technical safeguards that reasonably and appropriately protect the confidentiality, integrity, and availability of the electronic protected health information that it receives, or transmits on behalf of the covered entity.
Ensure that any agent, including a subcontractor, to whom it provides such information, agrees to implement reasonable and appropriate safeguards.
Report to the covered entity any security incident of which it becomes aware.
Authorize termination of the contract by the covered entity, if the covered entity determines that the business associate has violated a material term of the agreement.

Such systems, methods, and computer program products facilitate secure and encrypted transmission of electronic protected health information (“EPHI”) between Healthcare Providers. They use high-grade encryption (e.g., AES 256-bit) during transmission of EPHI—verifiable through their certificate status with VeriSign—and 1024-bit encryption to protect data at rest within those systems.

Health plans may still need to be able to recognize each provider solely by its NPI. As the systems, methods, and computer program products disclosed herein are not intended to act as a clearinghouse nor as an intermediary to Medicare/Medicaid Payors, documents transferred between healthcare professionals are not considered standard transactions and therefore do not require NPI heading information. Furthermore, as NPI's original purpose is to provide unique identification for these transactions, the data set which system users are required to submit during registration does in fact provide enough information for unique identification.

In alternative embodiments, hardwired circuitry may be used in place of or in combination with software instructions to implement features consistent with principles of the invention. Thus, implementations consistent with principles of the invention are not limited to any specific combination of hardware circuitry and software.

Exemplary embodiments may be embodied in many different ways as a software component. For example, it may be a stand-alone software package, a combination of software packages, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. It may also be embodied as a software package installed on a hardware device.

Application 106 may further comprise a secure means for creating and managing a voice-driven document to reduce costs and increase the accuracy of recording doctor/patient interactions. One suitable such means is Vemics NuScribe™, which is available from Vemics, Inc.

NuScribe uses advanced voice recognition technology available today and is broadly applicable to any type of healthcare organization—from single and group practices to large hospital organizations. NuScribe is available as an online service (NuScribe Online™) or as customer-managed deployments. Both include electronic prescribing through the SureScripts® network used by 80% of the nation's pharmacies.

NuScribe Online securely stores the doctor's documents in a virtual repository and uses password protected, 128-bit SSL encryption to protect the information held or inputted into the database. It is fully HIPAA-compliant and is compatible with most EMR (Electronic Medical Record) solutions currently in use.

NuScribe Online is an Internet-based application for creating and managing medical reports and documentation in a user-friendly environment. The document creation is accomplished by using the most accurate voice recognition engine available today. Customers can use NuScribe as a single user, or network the service throughout a larger group or enterprise. The system also allows the user to create and store documentation for printing, faxing or use with an EMR.

While various exemplary embodiments have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A system for networking healthcare professionals, comprising:
a plurality of clients, each of which is accessible by one or more physicians, nurses, or other healthcare professionals;
an application operating on a server, said application including means for universally sharing clinical data;
a network coupling said server and said plurality of client; and
means for securing said network in accordance with established privacy standards

2. The system of claim 1, wherein said healthcare professionals further comprise a health insurer.

3. The system of claim 1, wherein said network comprises one or more of a wireline network, a wireless network, a local area network (LAN), a metropolitan area network (MAN), a wide area networks (WAN), the Internet, an intranet, an extranet, and a virtual private network (VPN).

4. The system according to claim 1, wherein said securing means further comprises means for exchanging one or more messages and files in a manner compliant with the Health Insurance Portability and Accountability Act (HIPAA).

5. The system according to claim 4, wherein said HIPAA-compliant means for exchanging one or more messages and files comprises:
a browser operating on each of said plurality of clients; and
processing means for establishing a secure socket layer (SSL) connection between said browser and said server.

6. A system for networking healthcare professionals, comprising:
a secure networking application operating on a computer; and
a database server in communication with a database and with said messaging application;
wherein said networking application is configured to:
request data from said database with a query;
establish a member session with said database;
receive access to a plurality of database tables in a query plan;
establish a plurality of member sessions with said database;
receive query results from said plurality of member sessions; and
provide said query results to one or more destinations; and
wherein said database server is configured to:
receive said query;
generate said query plan;
process said query plan to obtain results; and
provide said results in to said networking application via said member sessions.

7. The system of claim 6, further comprising voice-driven means for creating and managing documents.

8. The system of claim 7, further comprising means for exchanging said document in a manner compliant with the Health Insurance Portability and Accountability Act (HIPAA).

9. The system of claim 6, wherein said networking application operates on a separate computer from said database server.

10. The system of claim 6, wherein said networking application operates on a plurality of clients.

11. A computer-implemented method of retrieving data from a database, comprising:
requesting data from a database with a query via a networking application;
establishing a member session with said database;
receiving information about a query plan;
establishing a plurality of member sessions with said database based on said received information;
receiving query results in from said plurality of member sessions; and
providing said query results to one or more destinations.

12. A computer-readable medium comprising computer-executable instructions that when executed on a processor provide result streams for a database query, the medium comprising:
one or more instructions for requesting data from a database with a query;
one or more instructions for establishing a member session with said database;
one or more instructions for receiving access to a query plan;
one or more instructions for establishing a plurality of member sessions with said database;
one or more instructions for receiving query results from said plurality of member sessions; and
one or more instructions for providing said query results to one or more destinations.
